(19) United States
(12) Patent Application Publication
(10) Pub. No.: US 2026/0206050 A1
(43) Pub. Date: Jul. 16, 2026

(54) INTERCELL COORDINATION FOR INTERFERENCE ESTIMATION AND NULLING

(71) Applicant: QUALCOMM Incorporated, San Diego, CA (US)

(72) Inventors: Chih-Hao LIU, San Diego, CA (US); Rajat PRAKASH, San Diego, CA (US); Jing SUN, San Diego, CA (US)

(21) Appl. No.: 19/017,352

(22) Filed: Jan. 10, 2025

(51) Int. Cl. H04W 72/541; H04L 5/00

(52) U.S. Cl. CPC H04W 72/541; H04L 5/0005; H04L 5/005

(57) ABSTRACT

A method for wireless communication at a first network entity and related apparatus are provided. In the method, the first network entity receives an inter-cell interference coordination (ICIC) message from a second network entity over an Xn interface between the second network entity and the first network entity. The ICIC message includes at least one of a set of start and length indicator value (SLIV) patterns or a bitmap for uplink or downlink transmissions of the second network entity with a user equipment (UE). The first network entity further performs an interference reduction process based on the ICIC message within a first ICIC period.

### TECHNICAL FIELD

The present disclosure relates generally to communication systems and, more particularly, to interference estimation and reference signal (RS) transmission in wireless communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first network entity. The apparatus may include at least one memory and at least one processor coupled to the at least one memory. Based at least in part on information stored in the at least one memory, the at least one processor may be configured to receive, from a second network entity over an Xn interface between the second network entity and the first network entity, an inter-cell interference coordination (ICIC) message, where the ICIC message includes at least one of a set of start and length indicator value (SLIV) patterns or a bitmap for uplink or downlink transmissions of the second network entity with a user equipment (UE); and perform an interference reduction process based on the ICIC message within a first ICIC period.

In an aspect of the disclosure, a method, a computer-readable medium, and an apparatus are provided for wireless communication at a serving network entity. The apparatus may include at least one memory and at least one processor coupled to the at least one memory. Based at least in part on information stored in the at least one memory, the at least one processor may be configured to transmit, to a neighbor network entity over an Xn interface between the serving network entity and the neighbor network entity, an ICIC message, where the ICIC message includes at least one of a set of SLIV patterns or a bitmap for uplink or downlink transmissions of the serving network entity with a UE; and communicate with the UE based on the ICIC message within a first ICIC period.

In an aspect of the disclosure, a method, a computer-readable medium, and an apparatus are provided for wireless communication at a first network entity. The apparatus may include at least one memory and at least one processor coupled to the at least one memory. Based at least in part on information stored in the at least one memory, the at least one processor may be configured to obtain a first common reference signal (RS) pattern for a slot for a first ICIC period, where the first common RS pattern includes a frequency domain (FD) pattern or a time domain (TD) pattern; communicate, with a UE, a sequence of RSs based on the first common RS pattern; and perform an interference reduction process based on the sequence of RSs during the first ICIC period.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating example frequency domain (FD) Rnn averaging boundaries.

FIG. 4B is a diagram illustrating example time domain (TD) Rnn averaging boundaries.

FIG. 5A is a diagram illustrating example TD Rnn averaging boundaries.

FIG. 5B is a diagram illustrating example TD Rnn averaging boundaries.

FIG. 6 is a diagram illustrating examples of Rnn reference signal (RS) in time and frequency domains.

FIG. 7 is a diagram illustrating inter-cell communication via the Xn interface.

FIG. 8 is a diagram illustrating an example of Rnn RS configuration in accordance with various aspects of the present disclosure.

FIG. 9 is a diagram illustrating the change of TD and FD Rnn averaging boundaries in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a first network entity in accordance with various aspects of the present disclosure.

FIG. 12 is a flowchart illustrating methods of wireless communication at a first network entity in accordance with various aspects of the present disclosure.

FIG. 13 is a flowchart illustrating methods of wireless communication at a serving network entity in accordance with various aspects of the present disclosure.

FIG. 14 is a flowchart illustrating methods of wireless communication at a first network entity in accordance with various aspects of the present disclosure.

FIG. 15 is a flowchart illustrating methods of wireless communication at a first network entity in accordance with various aspects of the present disclosure.

FIG. 16 is a diagram illustrating an example of a hardware implementation for an example apparatus and/or UE.

FIG. 17 is a diagram illustrating an example of a hardware implementation for an example network entity.

### DETAILED DESCRIPTION

In wireless communication, demodulation reference signals (DMRS) may be used for various tasks, including channel estimation and phase tracking, to ensure communication quality. When DMRS is not configured in the time domain (TD) or frequency domain (FD) windows, making DMRS-based estimation infeasible, alternative types of reference signals (RS) or null tones may be configured in these TD or FD windows, and averaging boundaries may be provided in the time or frequency domain based on the TD/FD interference patterns to keep the interference stationary and improve the accuracy of estimations based on the RS. To effectively manage inter-cell interference (e.g., interference affecting one cell's communication from a neighboring cell) in both downlink (DL) and uplink (UL) communications, a cell may obtain the information about inter-cell interference patterns from neighboring cells, and the cell may determine whether to avoid using interference resource blocks (RBs) or to implement interference nulling on these RBs. Additionally, since interference patterns may change over time, the cell may adaptively reconfigure the TD/FD averaging boundaries to maintain effective interference management. Example aspects presented herein provide methods and apparatus for information exchange mechanisms between the network cells, which facilitates the network cells to obtain assistance information for effective interference estimation and reference signal (RS) transmissions, including Rnn estimation and Rnn RS transmissions. As used herein “Rnn estimation” may refer to the estimation of the noise covariance matrix in a channel, and “Rnn RS” may refer to the RS used for the Rnn estimation.

Various aspects relate generally to wireless communication. Some aspects more specifically relate to interference estimation and nulling (or cancelation) in wireless communications. In some examples, a first network entity may receive, from a second network entity over an Xn interface between the second network entity and the first network entity, an inter-cell interference coordination (ICIC) message. The ICIC message may include at least one of a set of start and length indicator value (SLIV) patterns or a bitmap for uplink or downlink transmissions of the second network entity with a user equipment (UE). The first network entity may further perform an interference reduction process based on the ICIC message within a first ICIC period. In some aspects, the bitmap may include a resource block (RB) bitmap or a physical resource group (PRG) bitmap, and where the set of SLIV patterns may include a set of SLIV values. In some aspects, based on the set of SLIV patterns, the first network entity may configure a TD boundary for the interference reduction process. In some aspects, the first network entity may further configure one or more reference signal (RS) or null tones based on the TD boundary, and the boundaries of the one or more RS or null tones may be aligned with the TD boundary. In some aspects, a common RS pattern may be provided for a slot for a first ICIC period, and the common RS pattern may include a frequency domain (FD) pattern or a time domain (TD) pattern. In some aspects, the common RS pattern may be achieved across multiple network cells in a network through a consensus algorithm. During the process to achieve the common RS pattern, multiple network cells in the network may exchange ICIC messages, and these ICIC messages may include various message associated with the consensus algorithm used.

Particular aspects of the subject matter described in this disclosure can be implemented to realize one or more of the following potential advantages. In some examples, by enabling the communication of interference information, including TD or FD interference patterns and resource block (RB)/physical resource block group (PRG) bitmaps, between neighboring cells via an Xn interface, the described techniques improve the effectiveness of inter-cell interference management, thereby improving the quality of wireless communications. In some examples, by configuring TD and FD averaging boundaries based on interference patterns and aligning these boundaries with the configured RS or null tones, the described techniques enable more efficient source allocation that is adapted to real-time network conditions. In some examples, by enabling the communication of the information on the maximum rank of interference between neighboring cells, the describe techniques enable a cell to determine whether to employ interference nulling or adjust scheduling to avoid interference-prone resource blocks based on this information, thereby improving the efficiency of wireless communications.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

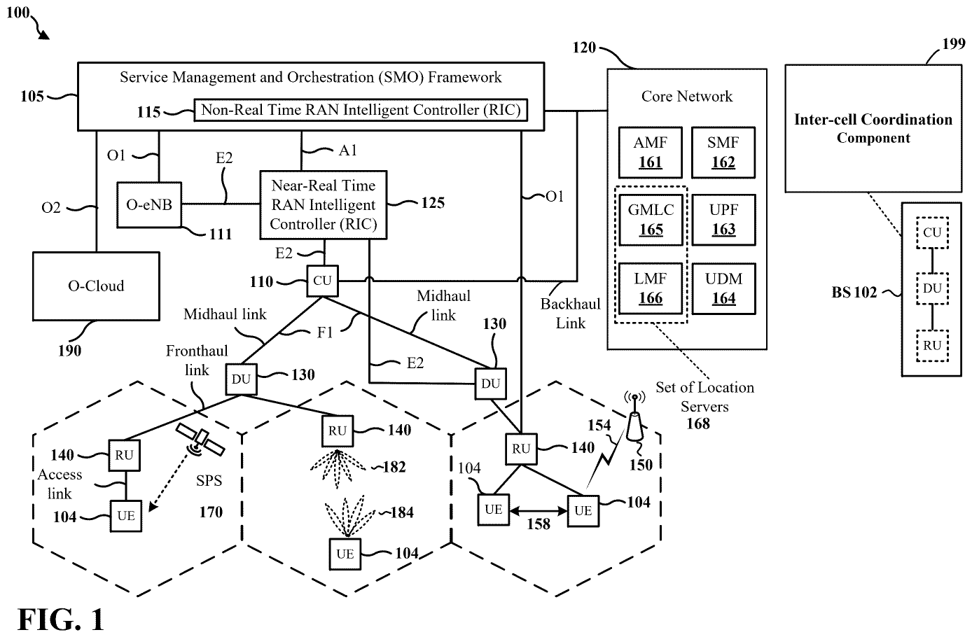

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may include the inter-cell coordination component 199. In some aspects, the inter-cell coordination component 199 may be configured to receive, from a second network entity over an Xn interface between the second network entity and the first network entity, an ICIC message, where the ICIC message includes at least one of a set of SLIV patterns or a bitmap for uplink or downlink transmissions of the second network entity with a UE; and perform an interference reduction process based on the ICIC message within a first ICIC period. In some aspects, the inter-cell coordination component 199 may be configured to obtain a first common RS pattern for a slot for a first ICIC period, where the first common RS pattern includes an FD pattern or a TD pattern; communicate, with a UE, a sequence of RSs based on the first common RS pattern; and perform an interference reduction process based on the sequence of RSs during the first ICIC period. Although the following description may be focused on 5G NR, the concepts described herein may be applicable to other similar areas, such as LTE, LTE-A, CDMA, GSM, and other wireless technologies.

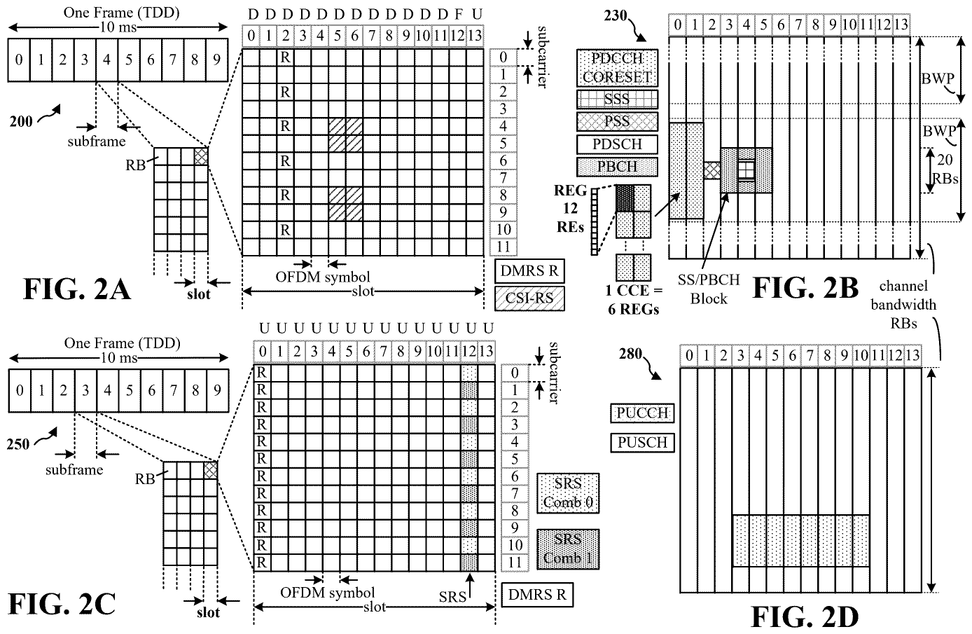

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

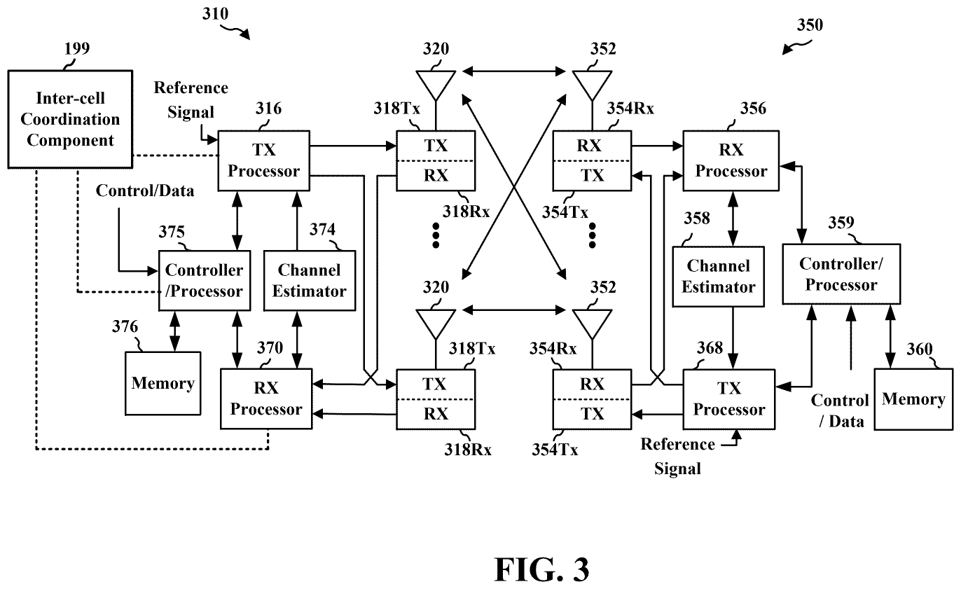

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the inter-cell coordination component 199 of FIG. 1.

In wireless communication, DMRS may be used for various tasks such as channel estimation and phase tracking to ensure communication quality. When DMRS is not configured in TD or FD windows, making DMRS-based estimation infeasible, alternative types of RS or null tones may be configured in these TD or FD windows, and averaging boundaries may be provided in the time or frequency domain based on the TD/FD interference patterns to keep the interference stationary and improve the accuracy of estimations based on the RS. To effectively manage inter-cell interference (e.g., interference affecting one cell's communication from a neighboring cell) in both downlink and uplink communications, a cell may obtain the information about inter-cell interference patterns from neighboring cells, and the cell may determine whether to avoid using interference RBs or to implement interference nulling on these RBs. Additionally, since interference patterns may change over time, the cell may adaptively reconfigure the TD/FD averaging boundaries to maintain effective interference management. Example aspects presented herein provide methods and apparatus for information exchange mechanisms between neighboring network cells, which facilitates the network cells to obtain assistance information for effective interference estimation and RS transmission, including the Rnn estimation and Rnn RS transmissions. For example, inter-cell interference coordination (ICIC) messages in cross-cell backhaul signaling between neighboring cells (e.g., via the Xn interface) may include potential SLIV patterns and RB/PRG bitmaps for DL/UL transmissions, which allows a cell to communicate with the neighboring cells (e.g., neighboring gNBs).

As used herein “Rnn estimation” may refer to the estimation of the noise covariance matrix of a channel, and “Rnn RS” may refer to the RS used for the Rnn estimation. For example, the covariance matrix of the noises present in a channel may be represented by Rₙₙ, and the channel matrix of this channel may be represented by H. Then, the “Rₙₙ estimation” refers to the estimation of the value of Run and may be implemented in various ways. In one example, the estimation of Rₙₙ (denoted as RNN) may be expressed:

$${\hat{R}}_{NN} = \frac{1}{N} \sum ( {Y}_{i} - {H}_{i} ) {( {Y}_{i} - {H}_{i} )}^{′} \qquad ( 1 )$$

where Yᵢ is the i-th received RS (e.g., at the i-th symbol) within the TD and FD averaging boundaries (or windows), and Hᵢ is the channel matrix for the i-th received RS. In another example, the estimation of Rₙₙ (e.g., \hat{R}_{NN}) may be based on the averaging of a combination of DMRS and null tones (e.g., a frequency component or subcarrier that carries no data or signal) within the TD and FD averaging boundaries (or windows). In another example, the estimation of Rₙₙ (e.g., \hat{R}_{NN}) may be based on the estimation of R_{yy} (which may be referred to as the “Ryy estimation”) within the TD and FD averaging boundaries (or windows), which may be expressed as:

$${R}_{yy} = \frac{1}{N} \sum {Y}_{i} {Y}_{i}^{′} \qquad ( 2 )$$

$${\hat{R}}_{NN} = {R}_{yy} - \frac{1}{N} \sum {\hat{H}}_{i} \cdot {\hat{H}}_{i}^{′} - {N}_{0} I \qquad ( 3 )$$

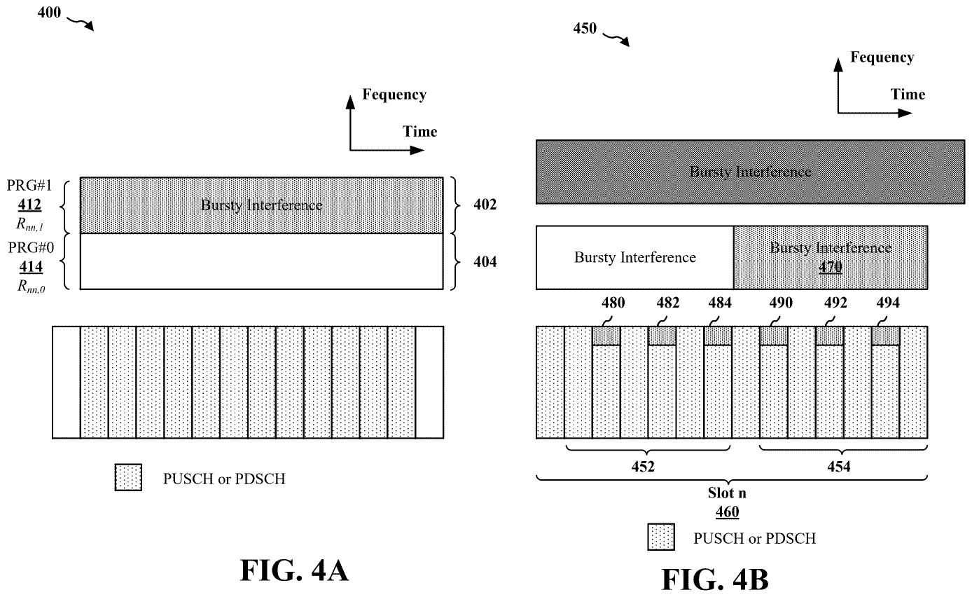

In wireless communication, the TD and FD averaging boundaries for the Rnn estimation may be based on interference patterns. By selecting proper TD and FD averaging boundaries, the receiver of RS may average the Rnn estimation from either the data tone or null tones, or RS tones within the TD/FD window to improve the accuracy of the Rnn estimation when DMRS symbols is not present. In some examples, the FD Rnn averaging window may be configured to align with the minimum PRG size in the network. FIG. 4A is a diagram 400 illustrating example FD Rnn averaging boundaries. As shown in FIG. 4A, the FD Rnn averaging boundary or window (e.g., 402, 404) may be configured to align with the minimum PRG size, such as the size of PRG #0 414 and PRG #1 412. Similarly, the start and end boundaries of the TD Rnn averaging boundary or window may be configured according to the potential start length indicator value (SLIV) pattern in the network. As used herein, the SLIV pattern is a pattern used to specify the start symbol and the length of the physical downlink shared channel (PDSCH) or physical uplink shared channel (PUSCH) allocation in a slot. FIG. 4B is a diagram 450 illustrating example TD Rnn averaging boundaries. As shown in FIG. 4B, the start and end boundaries of the TD Rnn averaging window (e.g., 452 and 454) may be configured according to the potential SLIV pattern in the network.

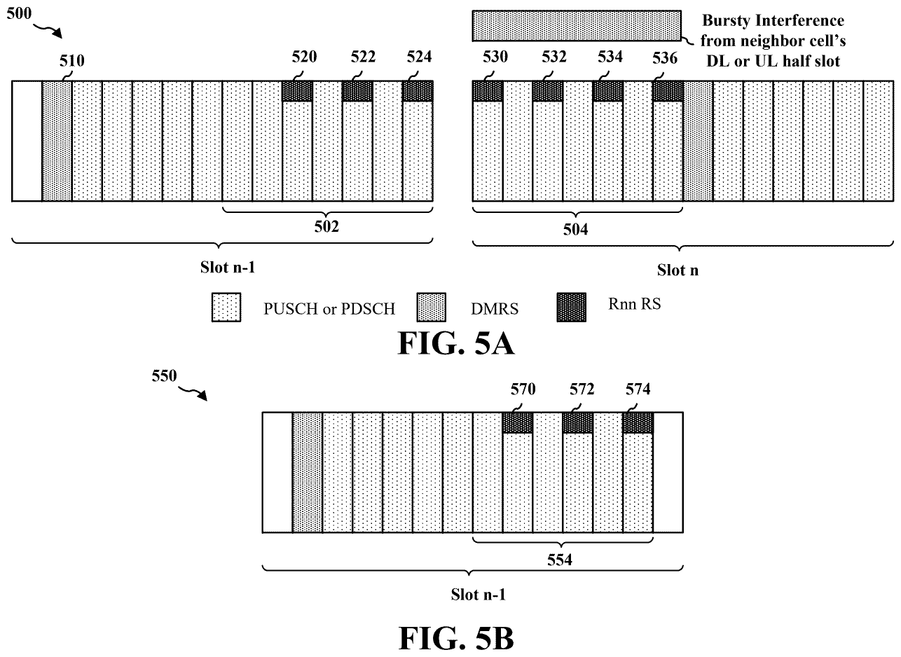

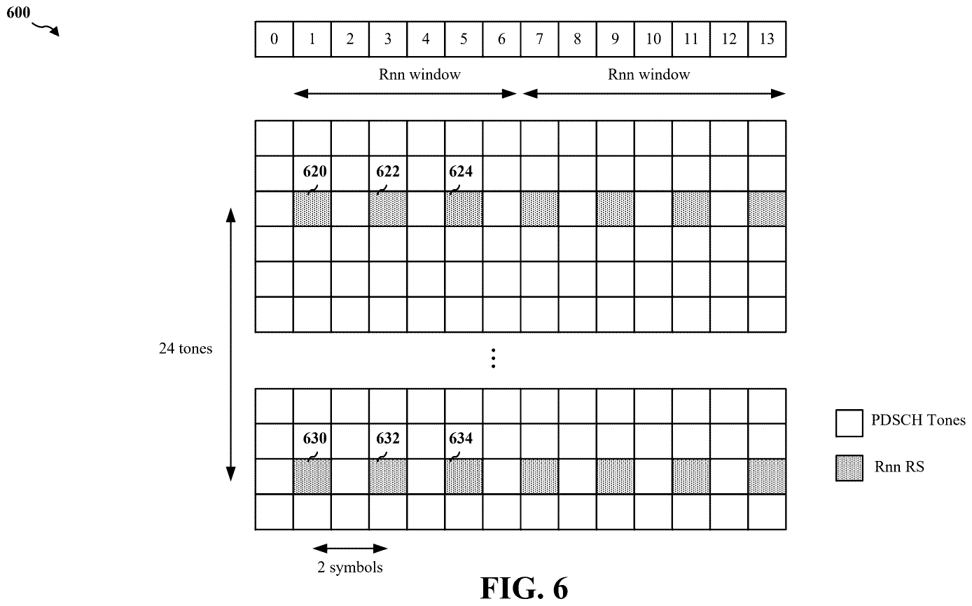

In some examples, based on the interference patterns observed in TD and FD (e.g., the bursty interference 470), the base station, such as a gNB, may configure the TD/FD Rnn averaging boundaries or windows. FIG. 5A and FIG. 5B diagrams illustrating example TD Rnn averaging boundaries. As shown in FIG. 5A, in diagram 500, in scenarios where no DMRS are present in these TD/FD Rnn averaging windows (e.g., when DMRS 510 is present outside the TD Rnn averaging window 502), low density Rnn RS, such as Rnn RS 520, 522, 524, may be configured. In some examples, the phase tracking reference signal (PTRS) may be used as a baseline to establish Rnn estimation RS (which may also be referred to as the “Rnn RS” in some aspects) for each FD window, which may be aligned with the TD Rnn averaging start and end boundaries. Additionally, to accurately measure the beacon interval (BI) from neighboring cells, the network may configure low density RS in each time segment and frequency domain window. For example, low density RS 520, 522, 524 may be configured in TD Rnn averaging window 502, and low density RS 530, 532, 534, 536 may be configured in TD Rnn averaging window 504. As shown in FIG. 5B, in diagram 550, low density RS 570, 572, 574, may be configured in TD Rnn averaging window 554. FIG. 6 is a diagram 600 illustrating examples of Rnn RS in time and frequency domains. As shown in FIG. 6, within these FD/TD Rnn averaging windows, the Rnn RS (e.g., Rnn RS 620, 622, 624, 630, 632, 634) may be configured at predetermined intervals, such as every first number (e.g., X) of symbols (e.g., every two symbols in FIG. 6) and every second number (e.g., Y) of tones (e.g., every 24 tones in FIG. 6).

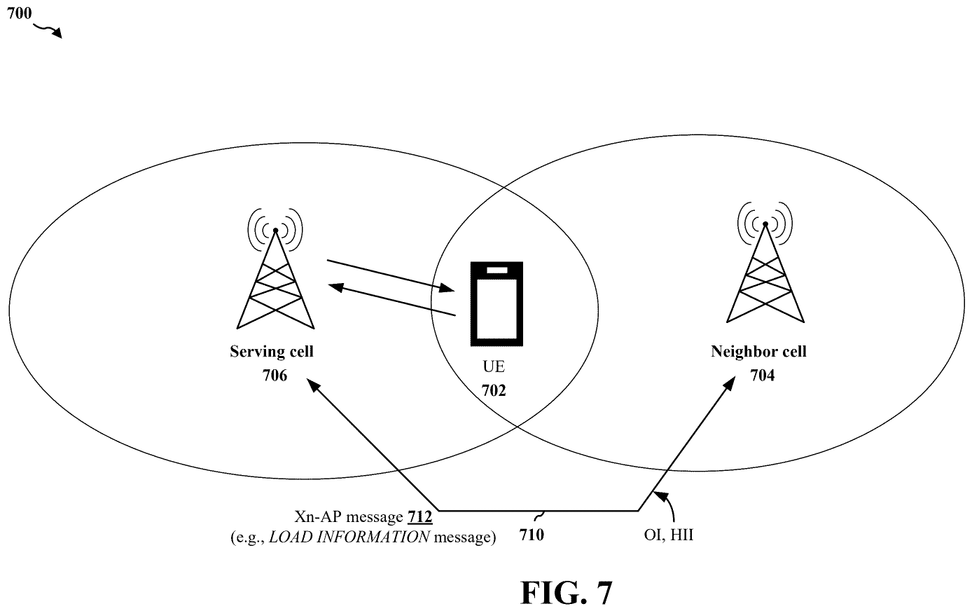

In inter-cell interference coordination (ICIC), the exchange of various indicators such as relative narrowband transmit power (RNTP), high interference indicator (HII), and overload indicator (OI) may facilitate a network cell manage and mitigate interference between cells. These indicators may be communicated via the Xn interface (e.g., X2 interface) between the network cells. FIG. 7 is a diagram 700 illustrating inter-cell communication via the Xn interface. As shown in FIG. 7, a serving cell 706 may be in communication with UE 702, and the serving cell 706 may communicate with a neighbor cell 704 via the Xn interface at 710 between the serving cell 706 and the neighbor cell 704. In some examples, in downlink interference coordination, RNTP may be defined in the LOAD INFORMATION message (e.g., Xn-AP message 712) for interference coordination in the downlink. For example, for each physical resource block (PRB), the RNTP may indicate whether the downlink transmission power is below a threshold indicated by the RNTP Threshold IE. That is, the transmitting cell (e.g., the serving cell 706) may indicate whether the downlink transmission power is higher or lower than a predetermined threshold value in an Xn-AP message to a neighbor cell (e.g., the neighbor cell 704). In some examples, the information provided by RNTP allows the receiving cell (e.g., the neighbor cell 704) to make informed decisions when scheduling its cell-edge terminals. For example, the receiving cell may avoid scheduling on the same PRBs to avoid interference.

In some examples, in uplink interference coordination, the uplink interference overload indication (OI) IE received in the LOAD INFORMATION message (e.g., Xn-AP message 712) may indicate the interference level experienced by the indicated cell on all resource blocks for each PRB. The receiving cell (e.g., the neighbor cell 704) may use this OI information when setting its scheduling policies to improve the interference situation faced by the transmitting cell (e.g., the serving cell 706) that has sent this OI. Additionally, the LOAD INFORMATION message (e.g., Xn-AP message 712) may include the uplink high interference indication IE, which may indicate PRBs that are potentially highly sensitive to interference according to the sending cell (e.g., the serving cell 706). With this information, the receiving cell (e.g., the neighbor cell 704) may avoid scheduling UEs at the cell edges on the PRBs that have been identified as sensitive to interference. This scheduling approach may reduce uplink interference to cell-edge transmissions within the receiving cell (e.g., the neighbor cell 704) but also in the cells of the network from which high interference indicator (HII) has been received.

In some examples, Rnn RS or null tones may be configured within TD/FD windows that do not include DMRS (and hence making DMRS-based Rnn estimation infeasible). For these Rnn RS or null tones, such as Rnn RS 620, 622, 624, TD/FD averaging boundaries may be configured based on the interference TD/FD patterns, such that the interference remains stationary to improve the accuracy of the Rnn estimations. Additionally, to reduce overhead for Rnn RS or null tones, the Rnn Rs or null tones may be configured exclusively in the interference resource blocks (RBs).

To effectively manage inter-cell interference (e.g., interference affecting one cell's communication from a neighboring cell) in both downlink and uplink communications, a cell may obtain the information about inter-cell interference patterns from one or more neighboring cells, and the cell may determine whether to avoid using interference RBs or to implement interference nulling on these RBs. Additionally, since interference patterns may change over time, the cell may adaptively reconfigure the TD/FD averaging boundaries to maintain effective interference management.

In some aspects, based on the Xn (e.g., X2) inter-cell interference coordination (ICIC) framework, a cell may communication with its neighboring cells via an Xn Application Protocol (Xn-AP) message. In some aspects, an Xn-AP message may include potential SLIV patterns, indicating the TD interference patterns to other cells. In some examples, an Xn-AP message may further include the RNTP (e.g., X2 RNTP) for downlink and high interference indicator (HII) for uplink transmissions, which may indicate the FD interference patterns to other cells.

In some aspects, to convey the TD and FD interference patterns to a neighboring cell (e.g., the neighbor cell 704), a cell (e.g., the serving cell 706) may transmit an Xn-AP ICIC message (e.g., the Xn-AP message 712), which may also be referred to as an “ICIC message” or “Xn-AP message” in some aspects, to the neighboring cell (e.g., the neighbor cell 704). The Xn-AP ICIC message (e.g., the Xn-AP message 712) may include potential SLIV patterns and RB or PRG bitmaps for DL and UL transmissions. The Xn-AP ICIC message (e.g., the Xn-AP message 712) may enable a cell (e.g., the serving cell 706) to communicate with neighboring cells (e.g., the neighbor cell 704) the potential SLIV patterns and RBs it plans to schedule following the ICIC period.

In some aspects, the SLIV patterns included in the Xn-AP ICIC message (e.g., Xn-AP message 712) may include a set of potential SLIV values. The DL RB bitmap may be similar to the RNTP, and the UL RB bitmap may be similar to the HII. The SLIV patterns in the Xn-AP ICIC message (e.g., Xn-AP message 712) may allow the neighboring cell (e.g., the neighbor cell 704) to configure the TD Rnn boundaries and Rnn RS or null tones, if necessary, such that the corresponding receiver may capture the intercell interference with the smallest time granularity. Referring to FIG. 4B, if the communicated interference SLIV patterns include two half-slots (e.g., two half-slots in slot n 460), the cell (e.g., gNB) may configure two TD Rnn averaging windows (e.g., 452 and 454) and configure one set of Rnn RS in each window (e.g., Rnn RS 480, 482, 484 in TD Rnn averaging window 452, and Rnn RS 490, 492, 494 in TD Rnn averaging window 454), thus effectively managing the interference and enhancing network performance.

In some aspects, the downlink or uplink RB bitmaps in the Xn-AP ICIC message may allow neighboring cells (e.g., the neighboring cell 704) to configure Rnn RS or Rnn null tones in the interference-affected RBs or PRGs. For example, the cell receiving the Xn-AP ICIC message (e.g., the neighbor cell 704), which may be referred to as the “target cell,” may avoid configuring Rnn RS or null tones outside these interference RBs to reduce the overhead. For DL interference, where a cell (e.g., gNB) serves multiple UEs, the precoding for each PRG may vary considerably. For UL interference, the precoding for different PRG may vary as well. Hence, the Rnn averaging boundaries may be aligned with the PRG boundaries, and at least one Rnn RS or null tone may be configured in the frequency domain for each interference PRG.

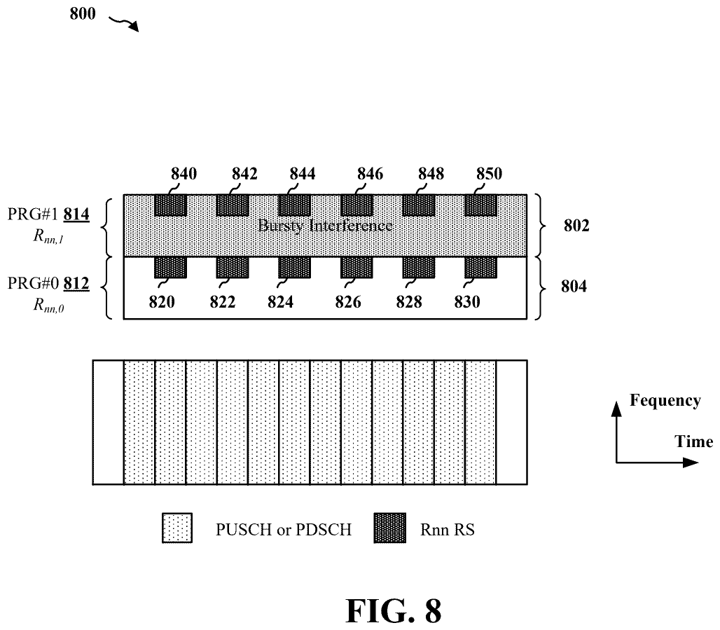

FIG. 8 is a diagram 800 illustrating an example of Rnn RS configuration in accordance with various aspects of the present disclosure. As show in FIG. 8, in some examples, a neighboring cell (e.g., the neighboring cell 704) might signal an Xn message indicating that it may potentially occupy PRG #0 812 and PRG #1 814. In response, the target cell (e.g., the cell receiving the Xn message) may configure Rnn RS in these PRGs accordingly. For example, the target cell may configure Rnn RS 820, 822, 824, 826, 828, 830, in PRG #0 812, and configure Rnn RS 840, 842, 844, 846, 848, 850, in PRG #1 814.

In some aspects, if the PRG sizes (e.g., the size of PRG #0 812 or PRG #1 814) are not aligned within the network, an Xn-AP ICIC message may include the PRG sizes for the physical downlink shared channel (PDSCH) or physical uplink shared channel (PUSCH). Hence, the FD Rnn averaging boundaries (e.g., the FD Rnn averaging boundaries 802, 804) may be aligned with the PRG boundaries of the interference cell (e.g., the PRG boundaries of PRG #0 812, and PRG #1 814), and at least one tone may be configured in each interference PRG.

In some aspects, the Xn-AP ICIC message (e.g., the Xn-AP message 712) may include the indication about the maximum rank of the transmission after the ICIC period, which allows the receiving cell (e.g., the target cell) to manage interference based on the capacity of its antennas relative to the complexity of the interference. For example, for low rank interference, the number of interfering signals may be less than or equal to the number of receive antennas. In these scenarios, interference nulling techniques may be implemented. However, when the rank of the interference exceeds the number of the receive antennas, interference nulling may not work, and the target cell (e.g., target gNB) may schedule the UE in different RBs other than the interference RBs. In some aspects, an Xn-AP ICIC message (e.g., the Xn-AP message 712) may include the maximum downlink or uplink rank of transmissions after the ICIC period. The maximum rank signaling from the neighboring cells may allow the target cell (e.g., the cell receiving the Xn-AP message) to determine whether it has enough freedom to null the interference effectively. In some examples, the maximum ranks for uplink and downlink transmissions may be independent of each other. In some examples, a network cell may have more antennas than a UE. Hence, nulling uplink interference is generally less challenging than UE nulling downlink interference. On the other hand, more sophisticated UEs (e.g., UE in 6G wireless communications) may have a relatively large number of antennas (e.g., up to eight antennas), and the process of interference nulling may become simpler compared to UE with a smaller number of antennas, for which the network may tend not to schedule transmissions on the interference RBs.

In some aspects, a procedure may be provided to specify how and when Xn-AP messages including the interference pattern may be exchanged between the neighboring cells (e.g., between serving cell 706 and neighbor cell 704) and how a network cell (e.g., a gNB) may apply the received interference pattern in an Xn-AP message for Rnn RS or null tones configuration. In some examples, this procedure may be based on the protocols used in ICIC, where Xn-AP ICIC messages may be exchanged among neighboring cells during a designated ICIC period and are subsequently applied to upcoming transmissions.

In some aspects, in the ICIC period, a network cell (e.g., gNB) may adjust the TD Rnn averaging boundaries or windows and configure Rnn RS or null tones after the network cell (e.g., gNB) receives TD and FD interference patterns from neighboring cells via Xn-AP messages. The adjustment on the TD Rnn averaging boundaries or windows may ensure that both the Rnn RS and null tones are placed within the smallest time and frequency grid of potential interference.

As used herein, an ICIC period may refer to the time duration over which interference management are applied across multiple cells in a network. In some examples, the ICIC period may be scheduled periodically, with the periodicity ranging from, for example, ten to a hundred milliseconds. In some examples, the ICIC period may be event-triggered. During these ICIC periods, the network cell (e.g., gNB) may update the TD/FD Rnn averaging boundaries and the configuration of Rnn RS/null tones. In some examples, the network cell (e.g., gNB) may also adjust the scheduling policies during these ICIC periods. For example, the network cell (e.g., gNB) may implement interference nulling on the interference RBs or, following some ICIC strategies, avoid scheduling on the interference RBs. At the beginning of the ICIC period, the interference management messages are also exchanged and applied.

In some aspects, the Rnn RS or null tone patterns may be adapted to the network conditions (e.g., the traffic load and traffic type). For example, based on the traffic load and type, the neighboring cell's SLIV pattern and FD pattern may change, which may be communicated with the target cell via an Xn-AP ICIC messages during the ICIC period. In some aspects, the ICIC period may be event-triggered or be periodical with a preconfigured periodicity, ranging from, for example, ten to hundreds of milliseconds.

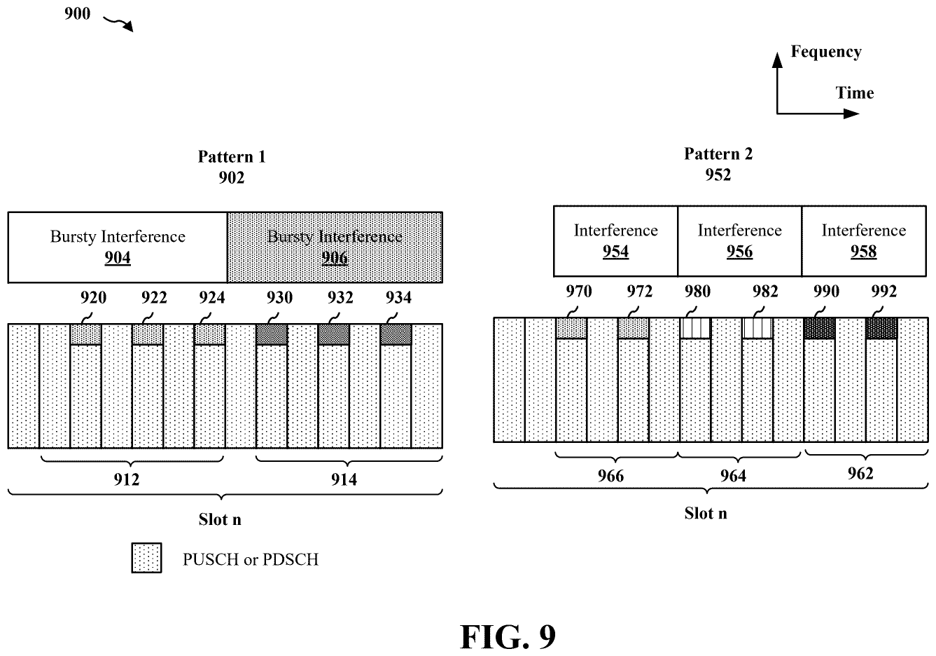

In some aspects, based on the changes in the SLIV pattern and FD pattern, the TD and FD Rnn averaging boundaries (e.g., the TD Rnn averaging window 452, 454, or the FD Rnn averaging boundaries 802, 804) and the configuration of RS or null tones (e.g., the configuration for Rnn RS 820, 822, etc.) may be updated to align with the SLIV pattern and FD pattern. FIG. 9 is a diagram 900 illustrating the change of TD and FD Rnn averaging boundaries in accordance with various aspects of the present disclosure. As shown in FIG. 9, in one ICIC period, the interference SLIV pattern (e.g., pattern 1 902) may include a seven-symbol half-slot pattern (e.g., the bursty interference 904, 906), while in another ICIC, the interference SLIV pattern (e.g., pattern 2 952) may include a 4-symbol mini-slot pattern (e.g., the interference 954, 956, or 958). Hence, for different ICIC periods, the target cell may configure different TD Rnn averaging boundaries accordingly and adjust the density and locations of the TD/FD Rnn RS or null tones to ensure that these tones are contained within the TD/FD Rnn averaging boundaries and that there is sufficient number REs to handle the interference effectively. For example, for the ICIC period where the interference SLIV pattern (e.g., pattern 1 902) includes a seven-symbol half-slot pattern (e.g., the bursty interference 904), the target cell may configure different TD Rnn averaging boundaries 912 and 914 to include six symbols in time domain to ensure that the Rnn RS are contained within the corresponding TD Rnn averaging boundaries (e.g., Rnn RS 920, 922, 924 in TD Rnn averaging boundary 912, and Rnn RS 930, 932, 934 in TD Rnn averaging boundaries 914). On the other hand, for the ICIC period where the interference SLIV pattern (e.g., pattern 2 952) includes a four-symbol mini-slot pattern (e.g., the interference 954), the target cell may configure different TD Rnn averaging boundaries 962 to include four symbols in time domain to ensure that the Rnn RS (e.g., Rnn RS 990, 992) are contained within the corresponding TD Rnn averaging boundaries 962.

In some aspects, the RRC in the target cell (which may be referred to as the “target RRC”) may configure or reconfigure the TD and FD Rnn averaging boundaries and the Rnn RS or null tones in each TD/FD Rnn averaging window. In some examples, the TD Rnn averaging boundaries within a slot (e.g., the boundary symbol index) may be configured by RRC. In some examples, the FD Rnn averaging boundaries (e.g., in terms of RBs) may be configured. For example, the FD Rnn averaging boundaries may be configured based on the ICIC downlink or uplink interference RB bitmap and PRG size, so that the Rnn averaging for the RS or null tones may be aligned with each interference PRG.

In some aspects, frequent ICIC information updates via RRC reconfiguration may lead to excessive overhead. To reduce the overhead, the network may preconfigure multiple TD/FD Rnn averaging boundary patterns and the associated Rnn RS or null tones patterns via RRC. Then, the network may indicate via, for example, downlink control information (DCI), the desired pattern following the ICIC period. For example, referring to FIG. 9, the network may preconfigure multiple TD Rnn averaging boundary patterns, where the first TD Rnn averaging boundary pattern may include TD Rnn averaging boundaries 912, 914, and the second TD Rnn averaging boundary pattern may include TD Rnn averaging window (e.g., TD Rnn averaging boundaries 962, 964, 966). The network may further indicate, via DCI, the desired pattern following the ICIC period.

Example aspects presented above provide new configurations for messages in the ICIC framework (e.g., ICIC messages) that enable the exchange of information, including potential SLIV patterns, frequency domain resource allocation (FDRA), and PRG configurations among neighboring cells. This exchange of information allows a target cell (e.g., the cell that receives the information) to configure both TD and FD Rnn averaging boundaries, and RS (e.g., data-carrying RS) within each TD/FD Rnn averaging window to capture downlink or uplink interference from neighboring cells. In some aspects, the frequency domain Rnn window may be aligned with the PRG size from the neighboring cells. Similarly, the time domain Rnn averaging start and end boundaries may be configured based on the potential SLIV patterns (e.g., pattern 1 902 or pattern 1 952) from the neighboring cells' Xn-AP messages. For each ICIC period, the cells may update the interference patterns with other neighboring cells, and the neighboring cells may update its FD/TD Rnn averaging window (e.g., TD Rnn averaging boundaries 912, 914, 962, 964, 966) and the RS pattern (e.g., Rnn RS 920, 922, etc.) accordingly.

In some aspects, based on the interference TD/FD patterns, a network entity (e.g., a gNB) may configure these TD/FD Rnn averaging boundaries or windows. When no DMRS is present within a TD/FD Rnn averaging window, low density Rnn RS (e.g., Rnn RS 920, 922, etc.) may be configured within the TD/FD Rnn averaging window (e.g., TD Rnn averaging boundary 912), facilitating the evaluation of the interference.

In some aspects, the network entity may, using a PTRS as a baseline, configure Rnn estimation RS (or Rnn RS) for each FD window based on the predetermined TD Rnn averaging start and end boundaries. For example, to measure the BI from neighboring cells, the network entity may configure low-density RS per time segments and per FD window. Within the FD/TD Rnn averaging windows, Rnn RS may be configured at a certain interval in the frequency domain and frequency domain, respectively (e.g., every two symbols and every 24 tones, as shown in FIG. 6). In some examples, the Rnn RS may be configured with preconfigured symbol and tone offsets.

In some examples, the quality of the Rnn estimation given the same number of Rnn RS REs may depend on the modulation order of the interference. For example, interference caused by quadrature phase shift keying (QPSK) may necessitate significantly fewer number of Rnn RS REs in each PRG to achieve the same level of normalized mean squared error (NMSE) as compared to interference from 64-quadrature amplitude modulation (64 QAM). For example, to achieve an NMSE of-10 dB in Rnn estimation, 12 Rnn RS REs are necessary for QPSK interference, whereas 36 Rnn RS REs are needed for 64 QAM interference. Hence, by aligning Rnn RS REs or data-carrying RS REs (which may be associated with a lower modulation order than other data transmissions) across cells, the overall quality of Rnn estimation based on the Rnn RS may be improved since Rnn RS from a QPSK random sequence and data-carrying RS may have a lower modulation order than the data. In some examples, each cell may maintain its own TD and FD Rnn averaging boundaries, depending on the specific TD/FD interference patterns.

In some aspects, the Rnn RS or data-carrying Rnn RS may be configured per TD and FD Rnn averaging boundaries. In some aspects, a common Rnn RS pattern may be provided across the entire network, so that Rnn RS from different cells in the network do not interfere with each other. In some aspects, the network entity may configure a common TD/FD Rnn RS pattern across all cells, and the RS pattern may be configured on a per-slot basis.

In some examples, the Rnn RS sequence may vary depending on the transmitter, which may be, for example, a base station for downlink interference or UE for uplink interference. Although Rnn RS sequences may vary for different cells, the same Rnn RS pattern may be used per slot across neighboring cells. For example, Rnn RS may be configured at regular intervals in the time and frequency domains, such as every M tones (with a tone offset) and every X symbols (with a symbol offset). For each transmission, Rnn RS may be contained within the TD/FD allocation boundaries for PUSCH or PDSCH.

In some aspects, a common Rnn RS TD/FD pattern RRC configuration across the neighboring cells (e.g., neighboring gNBs) may be provided, which may be dynamically adjusted for each ICIC period. To obtain a common Rnn RS TD/FD pattern, a consensus algorithm may be implemented among the neighboring cells (e.g., neighboring gNBs) to allow the exchanges of the configuration message for the synchronization of the common Rnn RS TD/FD pattern. As an example, referring to FIG. 6, the common Rnn RS TD/FD pattern may include the Rnn RS 620, 622, 624, 630, 632, 634. These Rnn RS may be configured at regular intervals in the time and frequency domains, such as every two symbols in the time domain and every 24 tones in the frequency domain.

In some aspects, the network CUs (e.g., gNB CUs) may operate in a distributed manner, and the Rnn RS TD/FD pattern may be adaptable to the interference patterns of neighboring cells to effectively capture and estimate the interference Rnn. Hence, consensus algorithms, such as Paxos or Raft algorithms may be employed, so that neighboring cells (e.g., neighboring gNBs) may reach agreement on common Rnn RS configuration values through the Xn interface. In some aspects, for the consensus algorithms to function effectively, the Xn-AP message may be defined to include the Rnn RS configuration, including a pattern index or a TD/FD pattern for each slot. In some examples, a new Rnn RS TD/FD pattern may be configured for each ICIC period. Hence, using Xn-AP messages to deliver the RRC configuration for the Rnn TD/FD pattern may be suitable.

In some aspects, to achieve a common Rnn configuration across the network for each ICIC period, consensus algorithms, such as the Paxos or Raft algorithms, may be used. For example, for each ICIC period, the TD and FD interference patterns in the neighboring cells may be exchanged across the neighboring cells so that a common Rnn configuration that is adapted to the TD and FD interference patterns may be achieved via the Paxos or Raft algorithms.

As an example, the Paxos algorithm may include three main phases: Prepare, Propose, and Learn. During the Prepare phase, a network cell (e.g., a gNB) may, acting as a Proposer, select a unique proposal number (e.g., n) and send a Prepare(n) message to a majority of other network cells (e.g., network gNBs), which may act as Acceptors. Each Acceptor, upon receiving the Prepare(n) message from the Proposer, may respond with a Promise(n, n′, v′) message not to accept any proposals with the proposal numbers less than n. In a Promise(n, n′, v′) message, n′ is the highest proposal number it has been previously accepted and v′ is the RRC configuration value associated with that proposal.

In the Propose phase, if the Proposer receives Promise responses from a majority of Acceptors, it may send an Accept(n, v) message, where v is the RRC configuration value associated with the highest proposal number in the Promise message it receives or a new value if no proposals were previously proposed. When an Acceptor receives the Accept (n, v) message, it will accept this proposal if it hasn't promised to consider a higher proposal number, and the Acceptor may send an Accepted (n, v) message back to the Proposer, confirming its acceptance of the proposal.

In the Learn (or consensus) phase, once the Proposer receives Accepted messages from a majority of Acceptors, a consensus on the RRC configuration value (v) is reached. The Proposer then may send a Learn (v) message to all the network cells (e.g., gNBs) in the network, indicating the final agreed-upon RRC configuration value (v).

As an example, the Raft algorithm may involve three roles among the network cells (e.g., gNBs): Leader, Followers, and Candidates. The Leader is the network cell (e.g., gNB) responsible for proposing and managing the agreement on the RRC configuration. The Followers are other network cells (e.g., gNBs) that receive the proposals from the Leader and confirm them. The Candidates are the network cells (e.g., gNBs) that potentially may transition into a Leader when the current Leader fails.

In Raft algorithm, the network may run the algorithm to select a network cell (e.g., gNB) as the Leader. This Leader then may be responsible for determining the common Rnn RS configuration and communicating the common Rnn RS configuration to all network cells (e.g., gNBs) via the Xn interface. As an example, in the Leader Election process, one network cell (e.g., gNB1) may be elected as the Leader based on a predetermined term. Initially, all network cells (e.g., gNBs) may start as Followers. If a Follower does not receive communication from the Leader within a time period, it may transition into a Candidate and send out a RequestVote message to other network cells (e.g., gNBs). Then, each Follower may send out a vote message, and the Candidate receiving the majority votes becomes the new Leader of the network for a set period of time.

Once the Leader has been selected, the Leader (e.g., gNB1) may propose a new RRC configuration (e.g., ConfigA), and communicate this proposed configuration (e.g., ConfigA) to other network cells (e.g., gNBs such as gNB2 and gNB3). In some examples, Followers may be allowed to contribute to the decision-making process by sending Xn-AP messages that signal TD/FD interferences, which may help the Leader in selecting the common configuration. After proposing the new RRC configuration (e.g., ConfigA), the other network cells (e.g., gNB2 and gNB3), as Followers, may append this new RRC configuration to their logs and send acknowledgments back to the Leader (e.g., gNB1). Upon receiving these acknowledgments from the other network cells (e.g., gNB2 and gNB3), the Leader (e.g., gNB1) may a Commit message, which finalizes the new RRC configuration (e.g., ConfigA) as the universally agreed-upon RRC configuration across the network.

In some aspects, to implement consensus algorithms, such as Paxos or Raft algorithms, in the Xn interface, Xn-AP ICIC messages may be defined to convey the Rnn RS configuration in various steps of the consensus algorithm such as the proposals, acceptances, and confirmations among the network cells (e.g., gNBs). The Xn-AP messages may be configured to enable network cells (e.g., gNBs) to reach a consensus on a common Rnn RS configuration. The structure of these Xn-AP messages may depend on the particular consensus algorithm (e.g., Paxos or Raft algorithms) in use.

In some aspects, when the Paxos algorithm is used as the consensus algorithm, the Xn-AP messages (e.g., Xn-AP message 712) may include a Prepare message, which may include the identifier (ID) of a network cell (e.g., gNB) and a priority value, which may be sent out by a network cell (e.g., gNB) acting as the proposer to the other network cells (e.g., gNBs) in the network. In some examples, the Xn-AP message (e.g., Xn-AP message 712) may further include a Promise message in response to the Prepare message. A Promise message may include information such as the source network ID (e.g., source gNB ID), the target network ID (e.g., target gNB ID), the previously promised RRC configuration, and the priority value. In some examples, the Xn-AP message (e.g., Xn-AP message 712) may further include an Accept and Accepted message. For example, the Accept and Accepted message may include the proposed RRC configuration and the source network ID (e.g., source gNB ID). In some examples, the Xn-AP message (e.g., Xn-AP message 712) may further include a Learn message. The Learn message may include the agreed-upon RRC configuration and the source network ID (e.g., source gNB ID). The Learn message may be used to propagate the agreed-upon RRC configuration to all the network cells (e.g., gNBs) in the network.

In some examples, when the Raft algorithm is used as the consensus algorithm, the Xn-AP messages (e.g., Xn-AP message 712) may include the messages used during the voting phase, including a RequestVote message and a Vote message. The RequestVote message may solicit votes from other network cells (e.g., gNBs) to vote the transmitting network cell (e.g., gNB) as the network leader, and the RequestVote message may include the candidate network cell ID (e.g., gNB ID) and the term number. The Vote message may include the ID of the network cell they are voting for and their own network ID (e.g., gNB ID). In the Raft algorithm, once a Leader is elected, the Leader may send out a Leader's Proposal message to the other network cells (e.g., gNBs). This message, which may be an Xn-AP message (e.g., Xn-AP message 712), may include the proposed common RRC configuration, including the common Rnn RS configuration the Leader proposes. To assist the Leader in determining a proper common Rnn RS RRC configuration, Follower (e.g., gNBs) may send additional Xn-AP messages (e.g., Xn-AP message 712) including their local TD and FD interference patterns to the Leader. These messages may help the Leader to determine the most effective common Rnn RS RRC configuration. In some aspects, an Xn-AP message (e.g., Xn-AP message 712) may further include an Acknowledge message from the Follower (e.g., gNBs) back to the Leader upon agreement of the proposed RRC configuration. The Acknowledge message may include the Follower network entity ID (e.g., gNB ID), confirming their acceptance and support of the Leader's decision.

In some aspects, to effectively implement consensus algorithms via the Xn interface, the Xn-AP ICIC messages (e.g., Xn-AP message 712) may be defined so that it can adequately convey the Rnn RS configuration (e.g., during the proposes, accept, and accepted stage of the consensus algorithms). In some aspects, the Xn-AP messages may include the Rnn RS configuration. These Xn-AP messages may allow the network cells (e.g., gNB) to reach a consensus on a common Rnn RS configuration to be used. For example, the Xn-AP messages (e.g., Xn-AP message 712) may include consensus Xn messages, such as the Promise and Learn messages in Paxos algorithm, or the Proposal messages in Raft algorithm. In some aspects, these consensus Xn messages may be included in an Information Element (IE) to indicate the Rnn RS configuration.

The Rnn RS configuration may be indicated in various ways. In some examples, a table of predefined TD and FD Rnn RS patterns may be provided. This table may list TD and FD Rnn RS patterns with different densities and offsets for these patterns and assign each pattern with a unique pattern index. In some examples, this table may be shared across all network cells (e.g., gNBs), allowing the Xn-AP message (e.g., Xn-AP message 712) to reference the pattern through a pattern index. In some examples, the Xn-AP message include the Rnn RS configuration IE, which may include parameters for the Rnn RS patterns, such as the density in the time domain and frequency domain, symbol offset, and tone offset.

In some examples, to maintain the same accuracy in Rnn estimation, a higher modulation order of interference may result in a higher number of Rnn RS REs. Hence, the density of Rnn RS or data-carrying Rnn RS may be adjusted based on the modulation order and rank of the interference. Therefore, information related to the modulation order and rank of the interference may be exchanged between the network cells to improve the Rnn Rs configuration. For example, when data-carrying RS are used and the time and frequency domain resources are aligned across the network cells, the modulation order and the rank of the interference from data-carrying RS in neighboring cells may affect the optimal time and frequency density of the data-carrying RS. For example, in the Raft algorithm, the leading network cell (e.g., gNB) may collect interference information from other network cells (e.g., gNBs) to determine a common data-carrying RS pattern that would be most effective across the network. In scenarios where the time and frequency resources for Rnn RS are not aligned, having information about the modulation order and the rank of the interference may allow the target cell to determine the Rnn RS density appropriately. In some aspects, the Xn-AP messages (e.g., Xn-AP message 712) may be used to communicate the maximum modulation order, modulation and coding scheme (MCS), and interference rank from the interfering network cell (e.g., gNB) to other network cells (e.g., other gNBs) in the network. For example, the interfering cell may determine the highest possible MCS or modulation order and rank in between the ICIC periods. This assessment may provide valuable information to cell edge UEs, as the links to those UEs are often the most probable sources of interference to neighboring cells. By evaluating the downlink and uplink connections involving these cell edge UEs, the interference cell may accurately determine the modulation order and rank that are causing interference. Once these parameters (e.g., the maximum MCS, modulation order, and rank) are determined, the interference cell may signal the maximum MCS, modulation order, and rank to other neighboring cells (e.g., neighboring gNBs) using Xn-AP messages. Aspects presented herein propose an information exchange between gNBs to obtain some kind of assistance information to help a serving gNB, and more specifically, propose to introduce cross-gNB backhaul signaling to indicate SLIV set information to help an Rnn estimation and an Rnn RS transmission. Some aspects may introduce an Xn-AP ICIC message which includes potential SLIV patterns, RB/PRG bitmaps for DL/UL, which allows a gNB to communicate to a neighboring gNB.

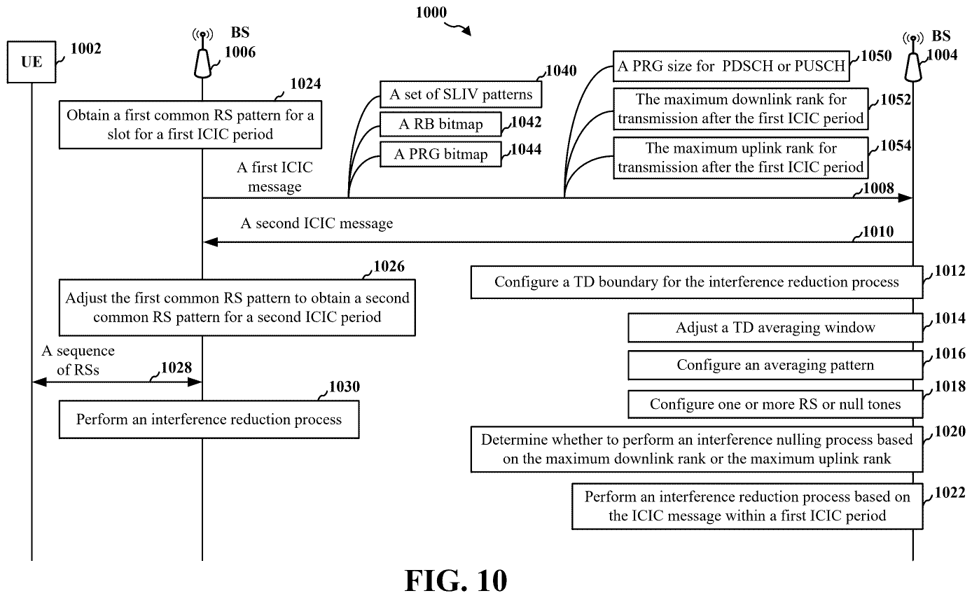

FIG. 10 is a call flow diagram 1000 illustrating a method of wireless communication in accordance with various aspects of this present disclosure. Various aspects are described in connection with a UE 1002, a first base station 1004, and a second base station 1006. The aspects may be performed by the UE 1002, the first base station 1004, or the second base station 1006, or by one or more components of the first base station 1004 or the second base station 1006 (e.g., a CU 110, a DU 130, and/or an RU 140). In some aspects, the second base station 1006 may be a serving base station that is in communication with the UE 1002. For example, the second base station 1006 may be the serving cell 706, which may be in communication with UE 702. The first base station 1004 may be a neighboring base station of the second base station 1006.

For example, the first base station 1004 may be the neighbor cell 704. The close proximity of the first base station 1004 and the second base station 1006 may lead to interference in their respective communication. Hence, an interference estimation and, if necessary, interference nulling or cancelation may be necessary at the first base station 1004 or the second base station 1006 to maintain the quality of wireless communication.

As shown in FIG. 10, at 1008, the second base station 1006 may transmit a first ICIC message to the first base station 1004. In some examples, the first ICIC message may include at least one of a set of SLIV patterns 1040 (e.g., pattern 1 902, pattern 2 952), or a bitmap for uplink or downlink transmissions of the second base station 1006 with UE 1002. For example, the bitmap may include an RB bitmap 1042 or a PRG bitmap 1044, and the set of SLIV patterns 1040 may include a set of SLIV values. In some examples, the first ICIC message may further include a PRG size 1050 for PDSCH or PUSCH. The PRG size may be used to align with FD averaging boundaries for one or more RS or null tones (e.g., at 1018). In some examples, the first ICIC message may further include the maximum downlink rank for transmission after the first ICIC period (e.g., at 1052), or the maximum uplink rank for the transmission after the first ICIC period (e.g., at 1054).

In some examples, the first base station 1004 and the second base station 1006 may exchange multiple ICIC messages. For example, at 1010, the second base station 1006 may receive a second ICIC message from the first base station 1004. For example, the exchanges of the ICIC messages may be related to a consensus algorithm, such as Paxos or Raft algorithm, so that the first base station 1004 and the second base station 1006 can reach an agreement on a common RS pattern to be used. For example, if the Paxos algorithm is used, each of the first ICIC message or the second ICIC message may include the Prepare message, the Promise message, the Accept message, the Accepted message, or the Learn message. For example, if the Raft algorithm is used, each of the first ICIC message or the second ICIC message may include the RequestVote message, the Vote message, or the Commit message.

At 1012, the first base station 1004 may configure, based on the set of SLIV patterns 1040, a TD boundary for the interference reduction process. For example, referring to FIG. 9, the first base station 1004 may configure, based on pattern 1 902, the TD Rnn averaging boundaries 912 and 914.

At 1014, the first base station 1004 may adjust a TD averaging window within the first ICIC period. For example, when the SLIV patterns changes from pattern 1 902 to pattern 2 952, the first base station may adjust the TD averaging window from TD Rnn averaging boundaries 912 and 914 to TD Rnn averaging boundaries 962, 964, 966.

At 1016, the first base station 1004 may configure an averaging pattern. For example, referring to FIG. 9, the averaging pattern may include one of pattern 1 902 or pattern 2 952.

At 1018, the first base station 1004 may configure one or more RS or null tones in the first ICIC period. In some examples, the one or more RS or null tones may be configured based on the TD boundary (e.g., at 1012). For example, the boundaries of the one or more RS or null tones may be aligned with the TD boundary. In some examples, the TD averaging window (e.g., at 1014) and the one or more RS or null tones may be located within a smallest time and frequency inference grid based on the first ICIC message (e.g., at 1008). For example, referring to FIG. 9, the one or more RS or null tones (e.g., Rnn RS 920, 922, 924) may be configured based on the TD Rnn averaging boundary 912.

At 1020, the first base station 1004 may determine whether to perform an interference nulling process based on the maximum downlink rank (e.g., at 1052) or the maximum uplink rank (e.g., at 1054).

At 1022, the first base station 1004 may perform an interference reduction process based on the ICIC message within a first ICIC period (e.g., the first ICIC message at 1008).

In some examples, the first base station 1004 and the second base station 1006 may communicate with each other to reach an agreement for a common RS pattern that may be used. During the process to reach the agreement for the common RS pattern, the first base station 1004 may, at 1024, obtain a first common RS pattern for a slot for the first ICIC period.

To reach an agreement of the common RS pattern to be used, the first base station 1004 and the second base station 1006 may exchange multiple ICIC messages, such as the first ICIC message at 1008 and the second ICIC message at 1010. Depending on the consensus algorithm used to reach the agreement (e.g., Paxos or Raft algorithm), the multiple ICIC messages may include the message specific to the consensus algorithm used. For example, if the Paxos algorithm is used, each of the first ICIC message or the second ICIC message may include the Prepare message, the Promise message, the Accept message, the Accepted message, or the Learn message. For example, if the Raft algorithm is used, each of the first ICIC message or the second ICIC message may include the RequestVote message, the Vote message, or the Commit message.

At 1026, the second base station 1006 may adjust, based on multiple ICIC messages between the first base station 1004 and the second base station 1006 over the Xn interface, the first common RS pattern to obtain a second common RS pattern for a second ICIC period.

At 1028, the second base station 1006 may communicate with UE 1002, a sequence of RSs. In some examples, the sequence of RS may be communicated between the second base station 1006 and UE 1002 based on the first common RS pattern. In some examples, the sequence of RS may be communicated between the second base station 1006 and UE 1002 based on the second common RS pattern.

At 1030, the second base station 1006 may perform an interference reduction process based on the sequence of RSs during the first ICIC period.

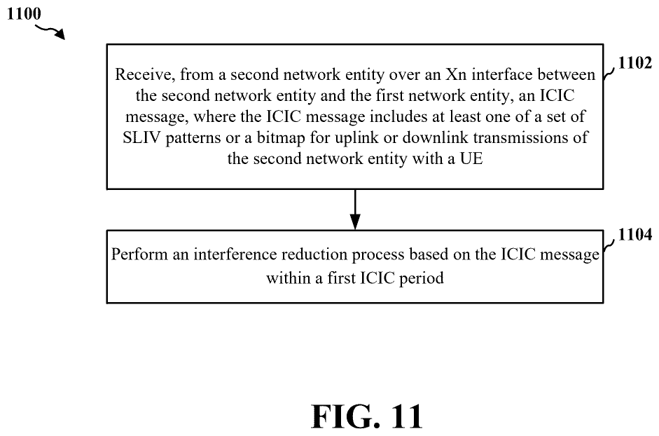

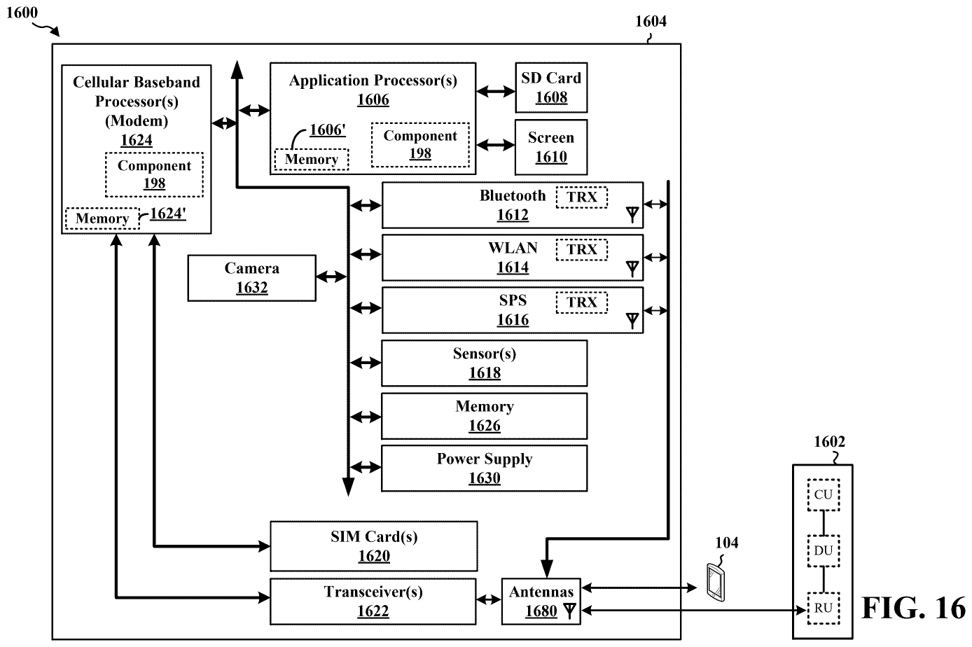

FIG. 11 is a flowchart 1100 illustrating methods of wireless communication at a first network entity in accordance with various aspects of the present disclosure. The method may be performed by the first network entity in collaboration with a second network entity and a UE. The first network entity may be the neighbor cell 704 or the first base station 1004. The second network entity may be the serving cell 706 or the second base station 1006. Each of the first network entity (or the first network cell) and the second network entity (or the second network cell) may be a base station, or a component of a base station, in the access network of FIG. 1 or a core network component (e.g., base station 102, 310; or the network entity 1602 in the hardware implementation of FIG. 16). The UE may be the UE 104, 350, 702, 1002, or the apparatus 1604 in the hardware implementation of FIG. 16. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

As shown in FIG. 11, at 1102, the first network entity may receive, from the second network entity over an Xn interface between the second network entity and the first network entity, an ICIC message. The ICIC message may include at least one of a set of SLIV patterns or a bitmap for uplink or downlink transmissions of the second network entity with the UE. FIG. 5A, FIG. 5B, FIG. 6, FIG. 7, FIG. 8, FIG. 9, and FIG. 10 illustrate various aspects of the steps in connection with flowchart 1100. For example, referring to FIG. 10, the first network entity (e.g., the first base station 1004) may, at 1008, receive from the second network entity (e.g., the second base station 1006) over an Xn interface between the second network entity (e.g., the second base station 1006) and the first network entity (e.g., the first base station 1004), an ICIC message. The ICIC message may include at least one of a set of SLIV patterns or a bitmap for uplink or downlink transmissions of the second network entity with the UE. In some aspects, 1102 may be performed by the inter-cell coordination component 199.

At 1104, the first network entity may perform an interference reduction process based on the ICIC message within a first ICIC period. For example, referring to FIG. 10, the first network entity (e.g., the first base station 1004) may, at 1022, perform an interference reduction process based on the ICIC message (e.g., at 1008) within a first ICIC period. In some aspects, 1104 may be performed by the inter-cell coordination component 199.

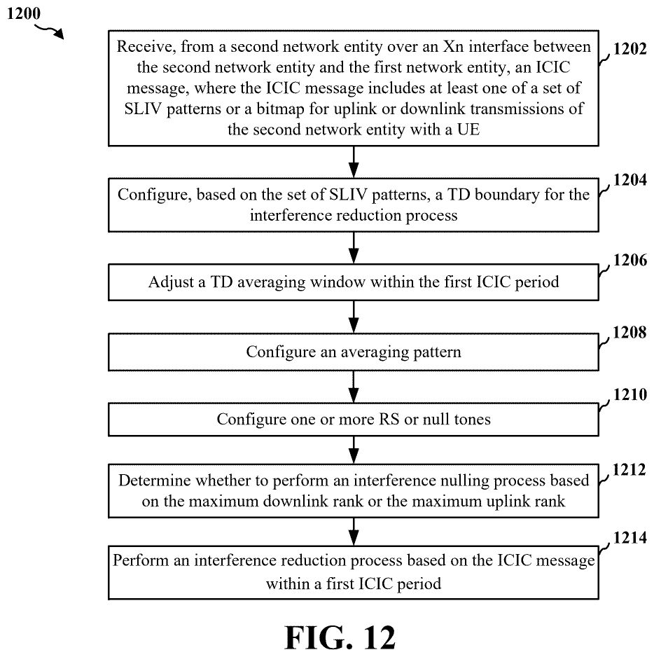

FIG. 12 is a flowchart 1200 illustrating methods of wireless communication at a first network entity in accordance with various aspects of the present disclosure. The method may be performed by the first network entity in collaboration with a second network entity and a UE. The first network entity may be the neighbor cell 704 or the first base station 1004. The second network entity may be the serving cell 706 or the second base station 1006. Each of the first network entity (or the first network cell) and the second network entity (or the second network cell) may be a base station, or a component of a base station, in the access network of FIG. 1 or a core network component (e.g., base station 102, 310; or the network entity 1602 in the hardware implementation of FIG. 16). The UE may be the UE 104, 350, 702, 1002, or the apparatus 1604 in the hardware implementation of FIG. 16. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

As shown in FIG. 12, at 1202, the first network entity may receive, from the second network entity over an Xn interface between the second network entity and the first network entity, an ICIC message. The ICIC message may include at least one of a set of SLIV patterns or a bitmap for uplink or downlink transmissions of the second network entity with the UE. FIG. 5A, FIG. 5B, FIG. 6, FIG. 7, FIG. 8, FIG. 9, and FIG. 10 illustrate various aspects of the steps in connection with flowchart 1200. For example, referring to FIG. 10, the first network entity (e.g., the first base station 1004) may, at 1008, receive from the second network entity (e.g., the second base station 1006) over an Xn interface between the second network entity (e.g., the second base station 1006) and the first network entity (e.g., the first base station 1004), an ICIC message. The ICIC message may include at least one of a set of SLIV patterns or a bitmap for uplink or downlink transmissions of the second network entity with the UE. In some aspects, 1202 may be performed by the inter-cell coordination component 199.

At 1214, the first network entity may perform an interference reduction process based on the ICIC message within a first ICIC period. For example, referring to FIG. 10, the first network entity (e.g., the first base station 1004) may, at 1022, perform an interference reduction process based on the ICIC message (e.g., at 1008) within a first ICIC period. In some aspects, 1214 may be performed by the inter-cell coordination component 199.

In some aspects, the bitmap may include an RB bitmap or a PRG bitmap, and the set of SLIV patterns may include a set of SLIV values. For example, referring to FIG. 10, the bitmap may include an RB bitmap 1042 or a PRG bitmap 1044, and the set of SLIV patterns may include a set of SLIV values.

In some aspects, at 1204, the first network entity may configure, based on the set of SLIV patterns, a TD boundary for the interference reduction process. For example, referring to FIG. 10, the first network entity (e.g., the first base station 1004) may, at 1012, configure, based on the set of SLIV patterns 1040, a TD boundary for the interference reduction process. In some aspects, 1204 may be performed by the inter-cell coordination component 199.

In some aspects, at 1210, the first network entity may configure one or more RS or null tones. In some examples, the first network entity may configure one or more RS or null tones based on the TD boundary (e.g., at 1204), and the boundaries of the one or more RS or null tones may be aligned with the TD boundary. For example, referring to FIG. 10, the first network entity may configure one or more RS or null tones. In some examples, the first network entity (e.g., the first base station 1004) may, at 1018 configure one or more RS or null tones based on the TD boundary (e.g., at 1012). Referring to FIG. 9, the boundaries of the one or more RS or null tones (e.g., Rnn RS 920, 922, 924) may be aligned with the TD boundary (e.g., TD Rnn averaging boundary 912). In some aspects, 1210 may be performed by the inter-cell coordination component 199.

In some aspects, the ICIC message may further include a PRG size for a PDSCH or a PUSCH. The FD averaging boundaries for the one or more RS or null tones may be aligned with the PRG size. For example, referring to FIG. 10, the ICIC message may further include a PRG size 1050 for a PDSCH or a PUSCH. Referring to FIG. 8, the FD averaging boundaries (e.g., 802, 804) for the one or more RS or null tones (e.g., Rnn RS 840, 842) may be aligned with the PRG size (e.g., size of PRG #0 812 or PRG #1 814).

In some aspects, at 1210, the first network entity may configure one or more RS or null tones in one or more interference blocks based on the bitmap. The one or more interference blocks may include interference RBs or interference PRGs. For example, referring to FIG. 10, the first network entity (e.g., the first base station 1004) may, at 1018, configure one or more RS or null tones in one or more interference blocks (e.g., the interference 954, 956, or 958) based on the bitmap. The one or more interference blocks (e.g., the interference 954, 956, or 958) may include interference RBs or interference PRGs.

In some aspects, each interference block of the one or more interference blocks may include at least one RS or null tone in a frequency domain, and the averaging boundaries for the one or more RS or null tones may be aligned with boundaries of each interference block. For example, referring to FIG. 9, each interference block of the one or more interference blocks (e.g., the interference 954, 956, or 958) may include at least one RS or null tone (e.g., Rnn RS 970, 972, 980, 982, 990, 992) in a frequency domain, and the averaging boundaries (e.g., TD Rnn averaging boundaries 962, 964, 966) for the one or more RS or null tones may be aligned with boundaries of each interference block blocks (e.g., the interference 954, 956, or 958).

In some aspects, the ICIC message may further include one or more of: the maximum downlink rank for transmission after the first ICIC period, or the maximum uplink rank for the transmission after the first ICIC period. For example, referring to FIG. 10, the ICIC message may further include one or more of: the maximum downlink rank for transmission after the first ICIC period (e.g., at 1052), or the maximum uplink rank for the transmission after the first ICIC period (e.g., at 1054).

In some aspects, at 1212, the first network entity may determine whether to perform an interference nulling process based on the maximum downlink rank or the maximum uplink rank. For example, referring to FIG. 10, the first network entity (e.g., the first base station 1004) may, at 1020, determine whether to perform an interference nulling process based on the maximum downlink rank or the maximum uplink rank. In some aspects, 1212 may be performed by the inter-cell coordination component 199.

In some aspects, at 1206, the first network entity may adjust a TD averaging window within the first ICIC period. At 1210, the first network entity may configure one or more RS or null tones in the first ICIC period, where the TD averaging window and the one or more RS or null tones may be located within the smallest time and frequency inference grid based on the ICIC message. For example, referring to FIG. 10, the first network entity (e.g., the first base station 1004) may, at 1014, adjust a TD averaging window within the first ICIC period. In some aspects, 1206 may be performed by the inter-cell coordination component 199.

In some aspects, the first ICIC period may be one of a set of ICIC periods having a periodicity. For example, referring to FIG. 10, the first ICIC period (e.g., at 1052 or 1054) may be one of a set of ICIC periods having a periodicity.

In some aspects, the first ICIC period may be triggered by a triggering event. For example, referring to FIG. 10, the first ICIC period (e.g., at 1052 or 1054) may be triggered by a triggering event.

In some aspects, at 1208, the first network entity may configure, via radio resource control (RRC) signaling, an averaging pattern. At 1210, the first network entity may configure one or more RS or null tones within the averaging pattern, and the averaging pattern may include one or more of a TD averaging window or an FD averaging window. For example, referring to FIG. 10, the first network entity (e.g., the first base station 1004) may, at 1016, configure, via RRC signaling, an averaging pattern. For example, referring to FIG. 9, the averaging pattern may include one of pattern 1 902 or pattern 2 952. In some aspects, 1208 may be performed by the inter-cell coordination component 199.

In some aspects, to configure the averaging pattern and the one or more RS or null tones within the averaging pattern, the first network entity may configure, based on the bitmap and a PRG size, the averaging pattern and the one or more RS or null tones within the averaging pattern. For example, referring to FIG. 10, the first network entity (e.g., the first base station 1004) may, at 1016, configure, based on the bitmap and a PRG size, the averaging pattern (e.g., pattern 1 902 or pattern 2 952) and the one or more RS or null tones (e.g., Rnn RS 920, 970, etc.) within the averaging pattern.

In some aspects, to configure the averaging pattern and the one or more RS or null tones within the averaging pattern, the first network entity may receive, via downlink control information (DCI), an indicator that indicates the averaging pattern from multiple preconfigured averaging patterns. For example, referring to FIG. 10, the first network entity (e.g., the first base station 1004) may receive, via DCI, an indicator that indicates the averaging pattern (e.g., at 1016) from multiple preconfigured averaging patterns.

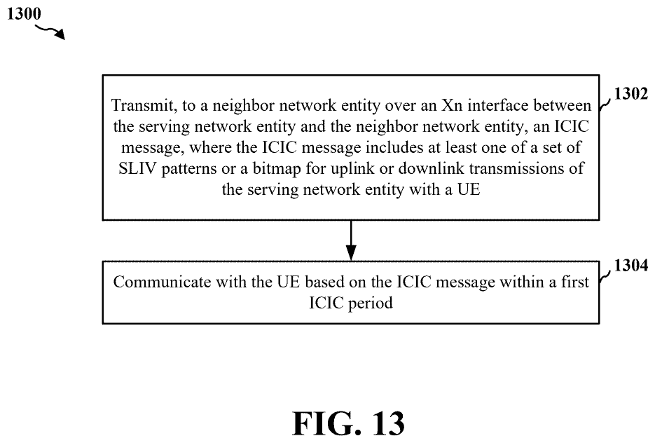

FIG. 13 is a flowchart 1300 illustrating methods of wireless communication at a serving network entity in accordance with various aspects of the present disclosure. The method may be performed by the serving network entity in collaboration with a neighbor network entity and a UE. The serving network entity may be the serving cell 706, the second base station 1006. The neighbor network entity may be the neighbor cell 704 or the first base station 1004. Each of the serving network entity (or network cell) and the neighbor network entity (or network cell) may be a base station, or a component of a base station, in the access network of FIG. 1 or a core network component (e.g., base station 102, 310; or the network entity 1602 in the hardware implementation of FIG. 16). The UE may be the UE 104, 350, 702, 1002, or the apparatus 1604 in the hardware implementation of FIG. 16. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

As shown in FIG. 13, at 1302, the serving network entity may transmit, to the neighbor network entity over an Xn interface between the serving network entity and the neighbor network entity, an ICIC message. The ICIC message may include at least one of a set of SLIV patterns or a bitmap for uplink or downlink transmissions of the serving network entity with a UE. FIG. 5A, FIG. 5B, FIG. 6, FIG. 7, FIG. 8, FIG. 9, and FIG. 10 illustrate various aspects of the steps in connection with flowchart 1300. For example, referring to FIG. 10, the serving network entity (e.g., the second base station 1006) may, at 1008, transmit, to the neighbor network entity (e.g., the first base station 1004) over an Xn interface between the serving network entity (e.g., the second base station 1006) and the neighbor network entity (e.g., the first base station 1004), an ICIC message (e.g., the Xn-AP message 712). The ICIC message (e.g., the Xn-AP message 712) may include at least one of a set of SLIV patterns 1040 or a bitmap for uplink or downlink transmissions of the serving network entity with a UE. In some aspects, 1302 may be performed by the inter-cell coordination component 199.

In some aspects, at 1304, the serving network entity may communicate with the UE based on the ICIC message within a first ICIC period. For example, referring to FIG. 10, the serving network entity (e.g., the second base station 1006) may, at 1028, communicate with the UE 1002 based on the ICIC message within a first ICIC period. In some aspects, 1304 may be performed by the inter-cell coordination component 199.

In some aspects, the bitmap may include an RB bitmap or a PRG bitmap. The set of SLIV patterns may include a set of SLIV values. For example, referring to FIG. 10, the bitmap may include an RB bitmap 1042 or a PRG bitmap 1044. The set of SLIV patterns may include a set of SLIV values.

In some aspects, a TD averaging boundary may be aligned with one or more RS or null tones in one or more interference blocks, and the one or more interference blocks may include interference RBs or interference PRGs. For example, referring to FIG. 9, the boundaries of the one or more RS or null tones (e.g., Rnn RS 920, 922, 924) may be aligned with the TD averaging boundary (e.g., TD Rnn averaging boundary 912). The one or more interference blocks (e.g., the interference 954, 956, or 958) may include interference RBs or interference PRGs.

In some aspects, each interference block may include at least one RS or null tone in the frequency domain. For example, referring to FIG. 9, each interference block of the one or more interference blocks (e.g., the interference 954, 956, or 958) may include at least one RS or null tone (e.g., Rnn RS 970, 972, 980, 982, 990, 992) in the frequency domain.

In some aspects, the ICIC message may further include a PRG size for the PDSCH or the PUSCH, and the FD averaging boundaries for one or more RS or null tones may be aligned with the PRG size. For example, referring to FIG. 10, the ICIC message (e.g., the first ICIC message at 1008) may further include a PRG size 1050 for the PDSCH or the PUSCH, and the FD averaging boundaries (e.g., 802, 804) for one or more RS or null tones may be aligned with the PRG size (e.g., the size of PRG #0 812 or PRG #1 814).

In some aspects, the ICIC message may further include one or more of: the maximum downlink rank for transmission after the first ICIC period, or the maximum uplink rank for the transmission after the first ICIC period. For example, referring to FIG. 10, the ICIC message (e.g., the first ICIC message at 1008) may further include one or more of: the maximum downlink rank for transmission after the first ICIC period (e.g., at 1052), or the maximum uplink rank for the transmission after the first ICIC period (e.g., at 1054).

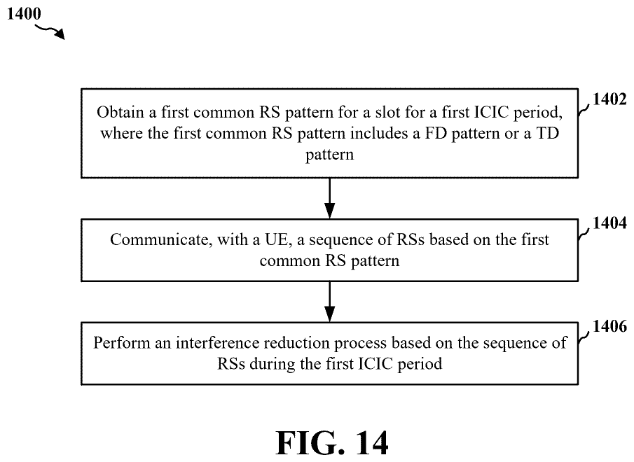

FIG. 14 is a flowchart 1400 illustrating methods of wireless communication at a first network entity in accordance with various aspects of the present disclosure. The method may be performed by the first network entity in collaboration with a second network entity and a UE. The first network entity may be the neighbor cell 704 or the first base station 1004. The second network entity may be the serving cell 706 or the second base station 1006. Each of the first network entity (or the first network cell) and the second network entity (or the second network cell) may be a base station, or a component of a base station, in the access network of FIG. 1 or a core network component (e.g., base station 102, 310; or the network entity 1602 in the hardware implementation of FIG. 16). The UE may be the UE 104, 350, 702, 1002, or the apparatus 1604 in the hardware implementation of FIG. 16. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

As shown in FIG. 14, at 1402, the first network entity may obtain a first common RS pattern for a slot for a first ICIC period. The first common RS pattern may include an FD pattern or a TD pattern. FIG. 5A, FIG. 5B, FIG. 6, FIG. 7, FIG. 8, FIG. 9, and FIG. 10 illustrate various aspects of the steps in connection with flowchart 1400. For example, referring to FIG. 10, the first network entity (e.g., the first base station 1004) may, at 1024, obtain a first common RS pattern for a slot for a first ICIC period. The first common RS pattern may include an FD pattern or a TD pattern. Referring to FIG. 6, the FD pattern may include one Rnn RS for every first number of tones (e.g., 24 tones), and the TD pattern may include one Rnn RS for every second number of symbols (e.g., two symbols). In some aspects, 1402 may be performed by the inter-cell coordination component 199.

At 1404, the first network entity may communicate a sequence of RSs with a UE based on the first common RS pattern. For example, referring to FIG. 10, the first network entity (e.g., the first base station 1004) may, at 1028, communicate a sequence of RSs with a UE 1002 based on the first common RS pattern. In some aspects, 1404 may be performed by the inter-cell coordination component 199.

At 1406, the first network entity may perform an interference reduction process based on the sequence of RSs during the first ICIC period. For example, referring to FIG. 10, the first network entity (e.g., the first base station 1004) may, at 1030, perform an interference reduction process based on the sequence of RSs during the first ICIC period. In some aspects, 1406 may be performed by the inter-cell coordination component 199.

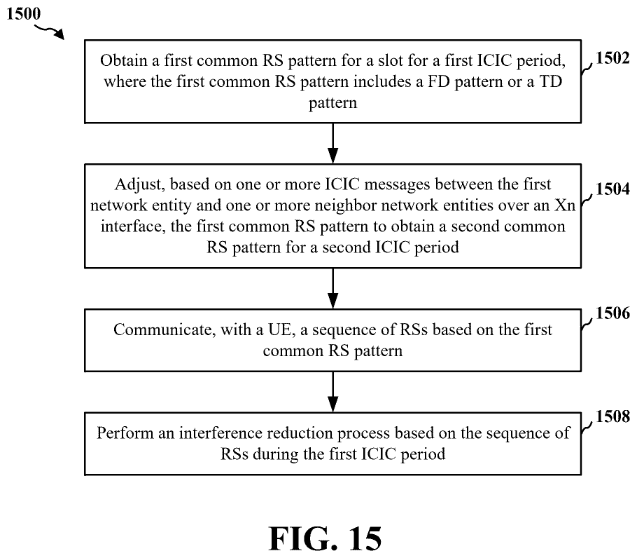

FIG. 15 is a flowchart 1500 illustrating methods of wireless communication at a first network entity in accordance with various aspects of the present disclosure. The method may be performed by the first network entity in collaboration with a second network entity and a UE. The first network entity may be the neighbor cell 704 or the first base station 1004. The second network entity may be the serving cell 706 or the second base station 1006. Each of the first network entity (or the first network cell) and the second network entity (or the second network cell) may be a base station, or a component of a base station, in the access network of FIG. 1 or a core network component (e.g., base station 102, 310; or the network entity 1602 in the hardware implementation of FIG. 16). The UE may be the UE 104, 350, 702, 1002, or the apparatus 1604 in the hardware implementation of FIG. 16. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

As shown in FIG. 15, at 1502, the first network entity may obtain a first common RS pattern for a slot for a first ICIC period. The first common RS pattern may include an FD pattern or a TD pattern. FIG. 5A, FIG. 5B, FIG. 6, FIG. 7, FIG. 8, FIG. 9, and FIG. 10 illustrate various aspects of the steps in connection with flowchart 1500. For example, referring to FIG. 10, the first network entity (e.g., the first base station 1004) may, at 1024, obtain a first common RS pattern for a slot for a first ICIC period. The first common RS pattern may include an FD pattern or a TD pattern. In some aspects, 1502 may be performed by the inter-cell coordination component 199.

At 1506, the first network entity may communicate a sequence of RSs with a UE based on the first common RS pattern. For example, referring to FIG. 10, the first network entity (e.g., the first base station 1004) may, at 1028, communicate a sequence of RSs with a UE 1002 based on the first common RS pattern. In some aspects, 1506 may be performed by the inter-cell coordination component 199.

At 1508, the first network entity may perform an interference reduction process based on the sequence of RSs during the first ICIC period. For example, referring to FIG. 10, the first network entity (e.g., the first base station 1004) may, at 1030, perform an interference reduction process based on the sequence of RSs during the first ICIC period. In some aspects, 1508 may be performed by the inter-cell coordination component 199.

In some aspects, at 1504, the first network entity may adjust, based on one or more ICIC messages between the first network entity and one or more neighbor network entities over an Xn interface, the first common RS pattern to obtain a second common RS pattern for a second ICIC period. For example, referring to FIG. 10, the first network entity (e.g., the first base station 1004) may, at 1026, adjust, based on one or more ICIC messages between the first network entity (e.g., the first base station 1004) and one or more neighbor network entities (e.g., the second base station 1006) over an Xn interface, the first common RS pattern to obtain a second common RS pattern for a second ICIC period. In some aspects, 1504 may be performed by the inter-cell coordination component 199.

In some aspects, the one or more ICIC messages may include one or more of: a first message comprising a source identifier (ID) for a network entity proposing a new RS pattern for the second ICIC period and a priority value associated with the new RS pattern, a second message comprising consensus information for a selection or a rejection of the new RS pattern by the neighbor network entities, a third message including an RRC configuration for the new RS pattern and a source ID for a network entity originating the third message, or a fourth message comprising the RRC configuration and the source ID for the network entity originating the fourth message for propagating the new RS pattern to the network entities. For example, referring to FIG. 10, the one or more ICIC messages (e.g., the first ICIC message at 1008 or the second ICIC message at 1010) may include one or more of: a first message comprising a source identifier (ID) for a network entity proposing a new RS pattern for the second ICIC period and a priority value associated with the new RS pattern, a second message comprising consensus information for a selection or a rejection of the new RS pattern by the neighbor network entities, a third message including an RRC configuration for the new RS pattern and a source ID for a network entity originating the third message, or a fourth message comprising the RRC configuration and the source ID for the network entity originating the fourth message for propagating the new RS pattern to the network entities.

In some aspects, the one or more ICIC messages may include one or more of: a first message including a request for a new RS pattern for the second ICIC period, a second message comprising consensus information for a selection or a rejection of the new RS pattern by the neighbor network entities, a third message including an RRC configuration for the new RS pattern, and a fourth message including network IDs for the neighbor network entities having adopted the new RS pattern. For example, referring to FIG. 10, the one or more ICIC messages (e.g., the first ICIC message at 1008 or the second ICIC message at 1010) may include one or more of: a first message including a request for a new RS pattern for the second ICIC period, a second message comprising consensus information for a selection or a rejection of the new RS pattern by the neighbor network entities, a third message including an RRC configuration for the new RS pattern, and a fourth message including network IDs for the neighbor network entities having adopted the new RS pattern.

In some aspects, the one or more ICIC messages may include an IE indicating an RS configuration, and the RS configuration may include a distribution of RSs in a time domain or a frequency domain. For example, referring to FIG. 10, the one or more ICIC messages (e.g., the first ICIC message at 1008 or the second ICIC message at 1010) may include an IE indicating an RS configuration, and the RS configuration may include a distribution of RSs (e.g., the distribution of Rnn RS 840, 842, 844, 820, 822, etc.) in the time domain or the frequency domain.

In some aspects, the IE may include a pattern index corresponding to the RS configuration.

In some aspects, the IE may include one or more of: the time domain density for the distribution of the RSs, the frequency domain density for the distribution of the RSs, the symbol offset corresponding to the distribution of the RSs, or the tone offset corresponding to the distribution of the RSs. For example, referring to FIG. 6, the IE may include one or more of: the time domain density for the distribution of the RSs (e.g., one Rnn RS, such as Rnn RS 620, 622, every two symbols), the frequency domain density (e.g., one Rnn RS, such as Rnn RS 620, 630, every 24 tones), for the distribution of the RSs, the symbol offset corresponding to the distribution of the RSs, or the tone offset corresponding to the distribution of the RSs.

In some aspects, the one or more ICIC messages may include one or more of: the maximum modulation order, the maximum modulation and coding scheme (MCS), or the interference rank. For example, referring to FIG. 10, the one or more ICIC messages (e.g., the first ICIC message at 1008 or the second ICIC message at 1010) may include one or more of: the maximum modulation order, the maximum modulation and coding scheme (MCS), or the interference rank.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to perform any of the aspects performed by the UE 1002 in FIG. 10. The component 198 may be within the cellular baseband processor(s) (or processing circuitry) 1624, the application processor(s) (or processing circuitry) 1606, or both the cellular baseband processor(s) (or processing circuitry) 1624 and the application processor(s) (or processing circuitry) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) (or processing circuitry) 1624 and/or the application processor(s) (or processing circuitry) 1606, includes means for performing any of the aspects performed by the UE 1002 in FIG. 10. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

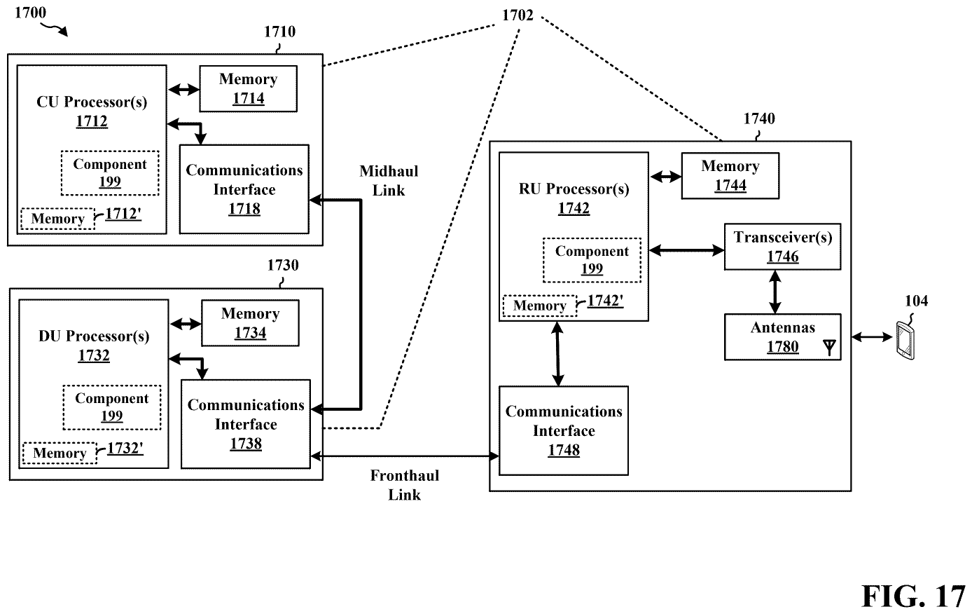

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a second network entity over an Xn interface between the second network entity and the first network entity, an ICIC message, where the ICIC message includes at least one of a set of SLIV patterns or a bitmap for uplink or downlink transmissions of the second network entity with a UE; and perform an interference reduction process based on the ICIC message within a first ICIC period. The component 199 may be further configured to perform any of the aspects described in connection with the flowcharts in FIG. 11, FIG. 12, FIG. 13, FIG. 14, and FIG. 15, and/or performed by the first base station 1004 in FIG. 10. The component 199 may be within one or more processors (or processing circuitry) of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for receiving, from a second network entity over an Xn interface between the second network entity and the first network entity, an ICIC message, where the ICIC message includes at least one of a set of SLIV patterns or a bitmap for uplink or downlink transmissions of the second network entity with a UE; and means for performing an interference reduction process based on the ICIC message within a first ICIC period. The network entity 1702 may further include means for performing any of the aspects described in connection with the flowcharts in FIG. 11, FIG. 12, FIG. 13, FIG. 14, and FIG. 15, and/or aspects performed by the first base station 1004 in FIG. 10. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first network entity. The method may include receiving, from a second network entity over an Xn interface between the second network entity and the first network entity, an ICIC message, where the ICIC message includes at least one of a set of SLIV patterns or a bitmap for uplink or downlink transmissions of the second network entity with a UE; and performing an interference reduction process based on the ICIC message within a first ICIC period. By enabling the communication of interference information, including TD or FD interference patterns and RB or PRG bitmaps, between neighboring cells via an Xn interface, the methods improve the effectiveness of inter-cell interference management, thereby improving the quality of wireless communications. Additionally, by configuring TD and FD averaging boundaries based on interference patterns and aligning these boundaries with the configured RS or null tones, the methods enable more efficient source allocation that is adapted to real-time network conditions. In some examples, by enabling the communication of the information on the maximum rank of interference between neighboring cells, the methods enable a cell to determine whether to employ interference nulling or adjust scheduling to avoid interference-prone resource blocks based on this information, thereby improving the efficiency of wireless communications.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first network entity. The method includes receiving, from a second network entity over an Xn interface between the second network entity and the first network entity, an inter-cell interference coordination (ICIC) message, wherein the ICIC message includes at least one of a set of start and length indicator value (SLIV) patterns or a bitmap for uplink or downlink transmissions of the second network entity with a user equipment (UE); and performing an interference reduction process based on the ICIC message within a first ICIC period.
Aspect 2 is the method of aspect 1, wherein the bitmap includes a resource block (RB) bitmap or a physical resource group (PRG) bitmap, and wherein the set of SLIV patterns include a set of SLIV values.
Aspect 3 is the method of any of aspects 1 to 2, where the method further includes configuring, based on the set of SLIV patterns, a time domain (TD) boundary for the interference reduction process.
Aspect 4 is the method of aspect 3, where the method further includes configuring, based on the TD boundary, one or more reference signal (RS) or null tones, wherein boundaries of the one or more RS or null tones are aligned with the TD boundary.
Aspect 5 is the method of aspect 4, wherein the ICIC message further includes a PRG size for a physical downlink shared channel (PDSCH) or a physical uplink shared channel (PUSCH), and wherein frequency domain (FD) averaging boundaries for the one or more RS or null tones are aligned with the PRG size.
Aspect 6 is the method of any of aspects 1 to 2, where the method further includes configuring, based on the bitmap, one or more reference signal (RS) or null tones in one or more interference blocks, wherein the one or more interference blocks include interference RBs or interference PRGs.
Aspect 7 is the method of aspect 6, wherein each interference block of the one or more interference blocks includes at least one RS or null tone in a frequency domain, and averaging boundaries for the one or more RS or null tones are aligned with boundaries of each interference block.
Aspect 8 is the method of any of aspects 1 to 2, wherein the ICIC message further includes one or more of: a maximum downlink rank for transmission after the first ICIC period, or a maximum uplink rank for the transmission after the first ICIC period.
Aspect 9 is the method of aspect 8, where the method further includes determining whether to perform an interference nulling process based on the maximum downlink rank or the maximum uplink rank.
Aspect 10 is the method of any of aspects 1 to 2, where the method further includes adjusting a time domain (TD) averaging window within the first ICIC period; and configuring one or more reference signal (RS) or null tones in the first ICIC period, wherein the TD averaging window and the one or more RS or null tones are located within a smallest time and frequency inference grid based on the ICIC message.
Aspect 11 is the method of any of aspects 1 to 2, wherein the first ICIC period is one of a set of ICIC periods having a periodicity.
Aspect 12 is the method of any of aspects 1 to 2, wherein the first ICIC period is triggered by a triggering event.
Aspect 13 is the method of any of aspects 1 to 2, where the method further includes configuring, via radio resource control (RRC) signaling, an averaging pattern and one or more reference signal (RS) or null tones within the averaging pattern, wherein the averaging pattern includes one or more of a time domain (TD) averaging window or a frequency domain (FD) averaging window.
Aspect 14 is the method of aspect 13, wherein configuring the averaging pattern and the one or more RS or null tones within the averaging pattern comprises: configuring, based on the bitmap and a PRG size, the averaging pattern and the one or more RS or null tones within the averaging pattern.
Aspect 15 is the method of aspect 13, wherein configuring the averaging pattern and the one or more RS or null tones within the averaging pattern comprises: receiving, via downlink control information (DCI), an indicator that indicates the averaging pattern from multiple preconfigured averaging patterns.
Aspect 16 is an apparatus for wireless communication at a first network entity, comprising: a processing system that includes processor circuitry and memory circuitry that stores code and is coupled with the processor circuitry, the processing system configured to cause the UE to perform the method of one or more of aspects 1-15.
Aspect 17 is an apparatus for wireless communication at a first network entity, comprising: at least one memory; and at least one processor coupled to the at least one memory and, where the at least one processor is configured to perform the method of any of aspects 1-15.
Aspect 18 is the apparatus for wireless communication at a first network entity, comprising means for performing each step in the method of any of aspects 1-15.
Aspect 19 is an apparatus of any of aspects 16-18, further comprising a transceiver configured to receive or to transmit in association with the method of any of aspects 1-15.
Aspect 20 is a computer-readable medium (e.g., a non-transitory computer-readable medium) storing computer executable code at a first network entity, the code when executed by at least one processor causes the at least one processor to perform the method of any of aspects 1-15.
Aspect 21 is a method of wireless communication at a serving network entity. The method includes transmitting, to a neighbor network entity over an Xn interface between the serving network entity and the neighbor network entity, an inter-cell interference coordination (ICIC) message, wherein the ICIC message includes at least one of a set of start and length indicator value (SLIV) patterns or a bitmap for uplink or downlink transmissions of the serving network entity with a user equipment (UE); and communicating with the UE based on the ICIC message within a first ICIC period.
Aspect 22 is the method of aspect 21, wherein the bitmap includes a resource block (RB) bitmap or a physical resource group (PRG) bitmap, and wherein the set of SLIV patterns include a set of SLIV values.
Aspect 23 is the method of any of aspects 21 to 22, wherein a time domain (TD) averaging boundary is aligned with one or more reference signal (RS) or null tones in one or more interference blocks, wherein the one or more interference blocks include interference RBs or interference PRGs.
Aspect 24 is the method of aspect 23, wherein each interference block includes at least one RS or null tone in a frequency domain.
Aspect 25 is the method of any of aspects 21 to 24, wherein the ICIC message further includes a PRG size for a physical downlink shared channel (PDSCH) or a physical uplink shared channel (PUSCH), and wherein frequency domain (FD) averaging boundaries for one or more RS or null tones are aligned with the PRG size.
Aspect 26 is the method of any of aspects 21 to 24, wherein the ICIC message further includes one or more of: a maximum downlink rank for transmission after the first ICIC period, or a maximum uplink rank for the transmission after the first ICIC period.
Aspect 27 is an apparatus for wireless communication at a serving network entity, comprising: a processing system that includes processor circuitry and memory circuitry that stores code and is coupled with the processor circuitry, the processing system configured to cause the network entity to perform the method of one or more of aspects 21-26.
Aspect 28 is an apparatus for wireless communication at a serving network entity, comprising: at least one memory; and at least one processor coupled to the at least one memory and, where the at least one processor is configured to perform the method of any of aspects 21-26.
Aspect 29 is the apparatus for wireless communication at a serving network entity, comprising means for performing each step in the method of any of aspects 21-26.
Aspect 30 is an apparatus of any of aspects 27-29, further comprising a transceiver configured to receive or to transmit in association with the method of any of aspects 21-26.
Aspect 31 is a computer-readable medium (e.g., a non-transitory computer-readable medium) storing computer executable code at a serving network entity, the code when executed by at least one processor causes the at least one processor to perform the method of any of aspects 21-26.
Aspect 32 is a method of wireless communication at a first network entity. The method includes obtain a first common reference signal (RS) pattern for a slot for a first inter-cell interference coordination (ICIC) period, wherein the first common RS pattern includes a frequency domain (FD) pattern or a time domain (TD) pattern; communicating, with a user equipment (UE), a sequence of RSs based on the first common RS pattern; and performing an interference reduction process based on the sequence of RSs during the first ICIC period.
Aspect 33 is the method of aspect 32, where the method further includes adjusting, based on one or more ICIC messages between the first network entity and one or more neighbor network entities over an Xn interface, the first common RS pattern to obtain a second common RS pattern for a second ICIC period.
Aspect 34 is the method of aspect 33, wherein the one or more ICIC messages include one or more of: a first message comprising a source identifier (ID) for a network entity proposing a new RS pattern for the second ICIC period and a priority value associated with the new RS pattern, a second message comprising consensus information for a selection or a rejection of the new RS pattern by the neighbor network entities, a third message comprising a radio resource control (RRC) configuration for the new RS pattern and a source ID for a network entity originating the third message, or a fourth message comprising the RRC configuration and the source ID for the network entity originating the fourth message for propagating the new RS pattern to the network entities.
Aspect 35 is the method of aspect 33, wherein the one or more ICIC messages include one or more of: a first message comprising a request for a new RS pattern for the second ICIC period, a second message comprising consensus information for a selection or a rejection of the new RS pattern by the neighbor network entities, a third message comprising a radio resource control (RRC) configuration for the new RS pattern, and a fourth message comprising network identifiers (IDs) for the neighbor network entities having adopted the new RS pattern.
Aspect 36 is the method of aspect 33, wherein the one or more ICIC messages include an information element (IE) indicating an RS configuration, wherein the RS configuration includes a distribution of RSs in a time domain or a frequency domain.
Aspect 37 is the method of aspect 36, wherein the IE comprises a pattern index corresponding to the RS configuration.
Aspect 38 is the method of aspect 36, wherein the IE includes one or more of: a time domain density for the distribution of the RSs, a frequency domain density for the distribution of the RSs, a symbol offset corresponding to the distribution of the RSs, or a tone offset corresponding to the distribution of the RSs.
Aspect 39 is the method of aspect 33, wherein the one or more ICIC messages include one or more of: a maximum modulation order, a maximum modulation and coding scheme (MCS), or an interference rank.
Aspect 40 is an apparatus for wireless communication at a first network entity, comprising: a processing system that includes processor circuitry and memory circuitry that stores code and is coupled with the processor circuitry, the processing system configured to cause the UE to perform the method of one or more of aspects 32-39.
Aspect 41 is an apparatus for wireless communication at a first network entity, comprising: at least one memory; and at least one processor coupled to the at least one memory and, where the at least one processor is configured to perform the method of any of aspects 32-39.
Aspect 42 is the apparatus for wireless communication at a first network entity, comprising means for performing each step in the method of any of aspects 32-39.
Aspect 43 is an apparatus of any of aspects 40-42, further comprising a transceiver configured to receive or to transmit in association with the method of any of aspects 32-39.
Aspect 44 is a computer-readable medium (e.g., a non-transitory computer-readable medium) storing computer executable code at a first network entity, the code when executed by at least one processor causes the at least one processor to perform the method of any of aspects 32-39.

What is claimed is:

1. An apparatus for wireless communication at a first network entity, comprising:
at least one memory; and
at least one processor coupled to the at least one memory and, based at least in part on information stored in the at least one memory, the at least one processor is configured to:
receive, from a second network entity over an Xn interface between the second network entity and the first network entity, an inter-cell interference coordination (ICIC) message, wherein the ICIC message includes at least one of a set of start and length indicator value (SLIV) patterns or a bitmap for uplink or downlink transmissions of the second network entity with a user equipment (UE); and
perform an interference reduction process based on the ICIC message within a first ICIC period.

2. The apparatus of claim 1, further comprising a transceiver coupled to the at least one processor, wherein to receive the ICIC message, the at least one processor is configured to receive the ICIC message via the transceiver, wherein the bitmap includes a resource block (RB) bitmap or a physical resource group (PRG) bitmap, and wherein the set of SLIV patterns include a set of SLIV values.

3. The apparatus of claim 2, wherein the at least one processor is further configured to:
configure, based on the set of SLIV patterns, a time domain (TD) boundary for the interference reduction process.

4. The apparatus of claim 3, wherein the at least one processor is further configured to:
configure, based on the TD boundary, one or more reference signal (RS) or null tones, wherein boundaries of the one or more RS or null tones are aligned with the TD boundary.

5. The apparatus of claim 4, wherein the ICIC message further includes a PRG size for a physical downlink shared channel (PDSCH) or a physical uplink shared channel (PUSCH), and wherein frequency domain (FD) averaging boundaries for the one or more RS or null tones are aligned with the PRG size.

6. The apparatus of claim 2, wherein the at least one processor is further configured to:
configure, based on the bitmap, one or more reference signal (RS) or null tones in one or more interference blocks, wherein the one or more interference blocks include interference RBs or interference PRGs.

7. The apparatus of claim 6, wherein each interference block of the one or more interference blocks includes at least one RS or null tone in a frequency domain, and averaging boundaries for the one or more RS or null tones are aligned with boundaries of each interference block.

8. The apparatus of claim 2, wherein the ICIC message further includes one or more of:
a maximum downlink rank for transmission after the first ICIC period, or
a maximum uplink rank for the transmission after the first ICIC period.

9. The apparatus of claim 8, wherein the at least one processor is further configured to:
determine whether to perform an interference nulling process based on the maximum downlink rank or the maximum uplink rank.

10. The apparatus of claim 2, wherein the at least one processor is further configured to:
adjust a time domain (TD) averaging window within the first ICIC period; and
configure one or more reference signal (RS) or null tones in the first ICIC period, wherein the TD averaging window and the one or more RS or null tones are located within a smallest time and frequency inference grid based on the ICIC message.

11. The apparatus of claim 2, wherein the first ICIC period is one of a set of ICIC periods having a periodicity.

12. The apparatus of claim 2, wherein the first ICIC period is triggered by a triggering event.

13. The apparatus of claim 2, wherein the at least one processor is further configured to:
configure, via radio resource control (RRC) signaling, an averaging pattern and one or more reference signal (RS) or null tones within the averaging pattern, wherein the averaging pattern includes one or more of a time domain (TD) averaging window or a frequency domain (FD) averaging window.

14. The apparatus of claim 13, wherein to configure the averaging pattern and the one or more RS or null tones within the averaging pattern, the at least one processor is configured to:
configure, based on the bitmap and a PRG size, the averaging pattern and the one or more RS or null tones within the averaging pattern.

15. The apparatus of claim 13, wherein to configure the averaging pattern and the one or more RS or null tones within the averaging pattern, the at least one processor is further configured to:
receive, via downlink control information (DCI), an indicator that indicates the averaging pattern from multiple preconfigured averaging patterns.

16. An apparatus for wireless communication at a serving network entity, comprising:
at least one memory; and
at least one processor coupled to the at least one memory and, based at least in part on information stored in the at least one memory, the at least one processor is configured to:
transmit, to a neighbor network entity over an Xn interface between the serving network entity and the neighbor network entity, an inter-cell interference coordination (ICIC) message, wherein the ICIC message includes at least one of a set of start and length indicator value (SLIV) patterns or a bitmap for uplink or downlink transmissions of the serving network entity with a user equipment (UE); and
communicate with the UE based on the ICIC message within a first ICIC period.

17. The apparatus of claim 16, further comprising a transceiver coupled to the at least one processor, wherein to transmit the ICIC message, the at least one processor is configured to transmit the ICIC message via the transceiver, wherein the bitmap includes a resource block (RB) bitmap or a physical resource group (PRG) bitmap, and wherein the set of SLIV patterns include a set of SLIV values.

18. The apparatus of claim 17, wherein a time domain (TD) averaging boundary is aligned with one or more reference signal (RS) or null tones in one or more interference blocks, wherein the one or more interference blocks include interference RBs or interference PRGs.

19. The apparatus of claim 18, wherein each interference block includes at least one RS or null tone in a frequency domain.

20. The apparatus of claim 16, wherein the ICIC message further includes a PRG size for a physical downlink shared channel (PDSCH) or a physical uplink shared channel (PUSCH), and wherein frequency domain (FD) averaging boundaries for one or more RS or null tones are aligned with the PRG size.

21. The apparatus of claim 16, wherein the ICIC message further includes one or more of:
a maximum downlink rank for transmission after the first ICIC period, or
a maximum uplink rank for the transmission after the first ICIC period.

22. An apparatus for wireless communication at a first network entity, comprising:
at least one memory; and
at least one processor coupled to the at least one memory and, based at least in part on information stored in the at least one memory, the at least one processor is configured to:
obtain a first common reference signal (RS) pattern for a slot for a first inter-cell interference coordination (ICIC) period, wherein the first common RS pattern includes a frequency domain (FD) pattern or a time domain (TD) pattern;
communicate, with a user equipment (UE), a sequence of RSs based on the first common RS pattern; and
perform an interference reduction process based on the sequence of RSs during the first ICIC period.

23. The apparatus of claim 22, further comprising a transceiver coupled to the at least one processor, wherein to obtain the first common RS pattern for the slot for the first ICIC period, the at least one processor is configured to obtain the first common RS pattern for the slot for the first ICIC period via the transceiver, and wherein the at least one processor is further configured to:
adjust, based on one or more ICIC messages between the first network entity and one or more neighbor network entities over an Xn interface, the first common RS pattern to obtain a second common RS pattern for a second ICIC period.

24. The apparatus of claim 23, wherein the one or more ICIC messages include one or more of:
a first message comprising a source identifier (ID) for a network entity proposing a new RS pattern for the second ICIC period and a priority value associated with the new RS pattern,
a second message comprising consensus information for a selection or a rejection of the new RS pattern by the neighbor network entities,
a third message comprising a radio resource control (RRC) configuration for the new RS pattern and a source ID for a network entity originating the third message, or
a fourth message comprising the RRC configuration and the source ID for the network entity originating the fourth message for propagating the new RS pattern to the network entities.

25. The apparatus of claim 23, wherein the one or more ICIC messages include one or more of:
a first message comprising a request for a new RS pattern for the second ICIC period,
a second message comprising consensus information for a selection or a rejection of the new RS pattern by the neighbor network entities,
a third message comprising a radio resource control (RRC) configuration for the new RS pattern, and
a fourth message comprising network identifiers (IDs) for the neighbor network entities having adopted the new RS pattern.

26. The apparatus of claim 23, wherein the one or more ICIC messages include an information element (IE) indicating an RS configuration, wherein the RS configuration includes a distribution of RSs in a time domain or a frequency domain.

27. The apparatus of claim 26, wherein the IE comprises a pattern index corresponding to the RS configuration.

28. The apparatus of claim 26, wherein the IE includes one or more of:
a time domain density for the distribution of the RSs,
a frequency domain density for the distribution of the RSs,
a symbol offset corresponding to the distribution of the RSs, or
a tone offset corresponding to the distribution of the RSs.

29. The apparatus of claim 23, wherein the one or more ICIC messages include one or more of:
a maximum modulation order,
a maximum modulation and coding scheme (MCS), or
an interference rank.

30. A method of wireless communication at a first network entity, comprising:
receiving, from a second network entity over an Xn interface between the second network entity and the first network entity, an inter-cell interference coordination (ICIC) message, wherein the ICIC message includes at least one of a set of start and length indicator value (SLIV) patterns or a bitmap for uplink or downlink transmissions of the second network entity with a user equipment (UE); and
performing an interference reduction process based on the ICIC message within a first ICIC period.
